(19) United States
(12) Patent Application Publication
(10) Pub. No.: US 2026/0161913 A1
(43) Pub. Date: Jun. 11, 2026

(54) PRINTING SYSTEM, PRINT CONTROL DEVICE, AND PRINTING METHOD

(71) Applicant: SEIKO EPSON CORPORATION, TOKYO (JP)

(72) Inventor: Akira ASAUMI, SHIOJIRI-SHI (JP)

(21) Appl. No.: 19/407,393

(22) Filed: Dec. 3, 2025

(30) Foreign Application Priority Data
Dec. 5, 2024 (JP) 2024-212459

(51) Int. Cl. G06K 15/02; G03G 15/00; G06K 15/00

(52) U.S. Cl. CPC G06K 15/186; G03G 15/502; G03G 15/5087; G03G 15/553; G06K 15/002; G06K 15/4075

(57) ABSTRACT

A printing system includes an acquisition section 81, an instruction section 82, a receiving section 83, and a printing section 50. The acquisition section 81 acquires recording material information RI relating to a plurality of recording materials having different colors. The instruction section 82 causes the generative AI module 31 to generate an image based on the recording material information RI. The receiving section 83 receives the generated image GI generated by the generative AI module 31. The printing section 50 prints the received generated image GI using recording material.

The present application is based on, and claims priority from JP Application Serial Number 2024-212459, filed Dec. 5, 2024, the disclosure of which is hereby incorporated by reference herein in its entirety.

### BACKGROUND

### 1. Technical Field

The present disclosure relates to a printing system, a print control device, and a printing method.

### 2. Related Art

For example, JP-A-2004-93817 discloses a color page printer of an electrophotographic printing system which prints using toners of respective colors of YMCK. A CPU constituting a microcomputer calculates the residual amount of toner of each color of YMCK. According to the residual amount of each color toner obtained as the calculation result, the CPU controls to reduce units of consumption of the two colors of toners that correspond to the minimum residual amount and to the second from the minimum residual amount.

Further, JP-A-2024-120131 discloses an illustration background image generation system in which a server and a plurality of user terminals are connected via a network. The server includes a prompt creation section that creates a prompt including an element corresponding to a tag when one or more tags selected by the user are received from the user terminal, an AI image generation section that generates an image based on the prompt, and an image output section that outputs the image. In recent years, there has been an increase in the number of occasions where users print AI images generated by AI in their preferred colors, and the remaining amount of recording material can easily vary.

However, although the technique of JP-A-2004-93817 can suppress variation in the recording material, the adjustment is limited to a range in which the balance of the color tone is not lost from the image to be printed, and therefore, the amount of the recording material that can be adjusted in one printing is small. Therefore, there is a problem that there is room for further improvement in suppressing variation in the recording material.

### SUMMARY

A printing system that solves the above problems includes an acquisition section configured to acquire recording material information relating to a plurality of recording materials having different colors; an instruction section configured to cause a generative AI module to generate an image based on the recording material information; a receiving section configured to receive a generated image generated by the generative AI module; and a printing section configured to print the received generated image using the recording material.

A print control device that solves the above problems is a print control device provided in a terminal device for giving a print instruction to a printing device and includes an acquisition section configured to acquire recording material information relating to a plurality of recording materials having different colors; an instruction section configured to cause a generative AI module to generate an image based on the recording material information; a receiving section configured to receive a generated image generated by the generative AI module; and an image transmission section configured to transmit the received generated image to a printing device configured to print the generated image using the recording material.

A printing method that solves the above problems includes acquiring recording material information relating to a plurality of recording materials having different colors; generating an image by a generative AI module based on the recording material information; and printing the generated image generated by the generative AI module using the recording material.

### BRIEF DESCRIPTION OF THE DRAWINGS

FIG. 1 is a schematic diagram illustrating a printing system according to an embodiment.

FIG. 2 is a block diagram illustrating an electrical configuration of the printing system.

FIG. 3 is a perspective view of the printing device.

FIG. 4 is a schematic diagram illustrating an input image.

FIG. 5 is a schematic diagram illustrating a screen including recording material information.

FIG. 6 is a schematic diagram illustrating a comparison process performed by a comparison section.

FIG. 7 is a schematic diagram illustrating a process of reducing the variation in the remaining amount of the recording material.

FIG. 8 is a schematic diagram illustrating a state in which the variation in the remaining amount of the recording material is reduced.

FIG. 9 is a schematic diagram illustrating an image generation confirmation screen.

FIG. 10 is a schematic diagram illustrating an image generation method selection screen.

FIG. 11 is a schematic diagram illustrating an image generation condition confirmation screen.

FIG. 12 is a schematic diagram illustrating a composite image designation screen.

FIG. 13 is a schematic diagram illustrating a generated image.

FIG. 14 is a schematic diagram illustrating a print confirmation screen.

FIG. 15 is a schematic diagram illustrating a save confirmation screen.

FIG. 16 is a sequence diagram illustrating a series of processes of the printing system.

FIG. 17 is a schematic diagram illustrating an input image in the second embodiment.

FIG. 18 is a schematic diagram illustrating a print selection screen on which a print target can be selected from among generated images.

FIG. 19 is a sequence diagram illustrating a series of processes of the printing system according to the third embodiment.

FIG. 20 is a schematic diagram illustrating an input image.

FIG. 21 is a schematic diagram illustrating a print selection screen on which a print target can be selected from an input image and a generated image.

FIG. 22 is a schematic diagram illustrating a comparison process performed by a comparison section in the fourth embodiment.

FIG. 23 is a schematic diagram illustrating a state in which the variation in the remaining amount of the recording material is reduced.

FIG. 24 is a schematic bottom view illustrating a configuration related to ejection of a recording material of a print head in a fifth embodiment.

### DESCRIPTION OF EMBODIMENTS

Hereinafter, an embodiment of a printing system will be described with reference to the drawings.

### Configuration of Printing System 10

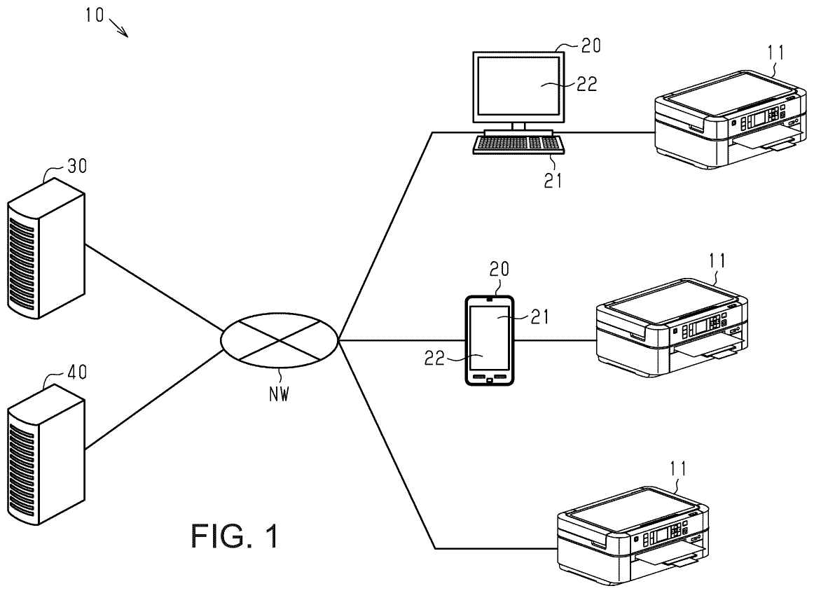

First, a configuration of a printing system 10 will be described with reference to FIG. 1. As illustrated in FIG. 1, the printing system 10 includes a printing device 11, a terminal device 20, and servers 30 and 40. The printing device 11 performs printing on a medium M such as a sheet of paper.

The printing device 11 and the terminal device 20 are connected to each other via a local area network (LAN) so as to be able to communicate with each other. The terminal device 20 and the servers 30 and 40 are communicably connected to each other through a network NW. The printing device 11 may be communicably connected to the servers 30 and 40 via the network NW.

The terminal device 20 may be, for example, a personal computer or a smartphone illustrated in FIG. 1. The terminal device 20 includes an input section 21 and a display section 22. The terminal device 20 may be, for example, a mobile phone, a personal digital assistant (PDA), a tablet PC, or the like.

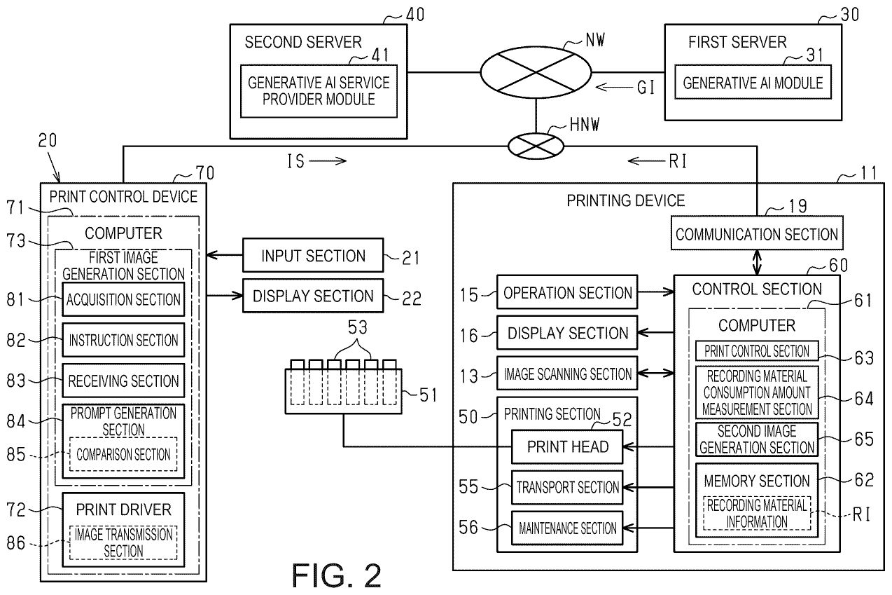

The first server 30 includes a generative AI module 31 (refer to FIG. 2). The second server 40 is a generative AI service providing server. The second server 40 includes a generative AI service provider module 41 (refer to FIG. 2). The second server 40 may be managed by the manufacturer or the sales company of the printing device 11. The second server 40 provides a service that makes it easy for the user to use the generative AI module 31, for example, by mediating between the terminal device 20 and the generative AI module 31 included in the first server 30.

### Configuration of the Printing Device 11

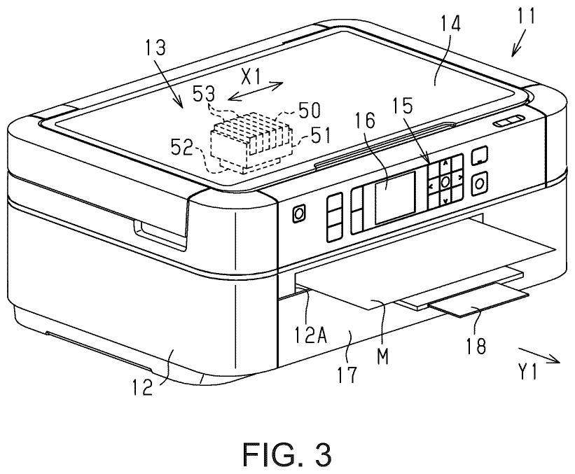

Next, a configuration of the printing device 11 will be described with reference to FIG. 3. As illustrated in FIG. 3, the printing device 11 is, for example, an ink jet printer. The printing device 11 is a so-called consumer printer used as a home printer at home or the like, but may be a business printer used in an office or the like. The printing device 11 is not limited to an ink jet printer, and may be an electrophotographic printer such as a laser printer that prints on the medium M using toner as ink. The printing device 11 may be a textile printer that performs printing on the medium M that is a fabric, or a printer that performs printing on a material such as a T-shirt as the medium M. The printing device 11 may be a printer that prints a transfer film, to which an image can be transferred, as the medium M by a direct to film (DTF) method.

The printing device 11, which is an ink jet printer, prints characters or images by ejecting ink, which is an example of a recording material, toward a medium M. The printing device 11 is also a liquid ejecting device that ejects liquid such as ink toward a medium such as paper.

As illustrated in FIG. 3, the printing device 11 includes a main body 12 having a substantially rectangular box shape. The printing device 11 includes an image reading section 13 on the upper side of a main body 12. The printing device 11 includes a cover 14 that is openable and closable on the upper side of the main body 12. The image reading section 13 is opened and closed together with the cover 14. The cover 14 is opened and closed between a closed position shown in FIG. 3 and an open position where the inside of the main body 12 is exposed.

The printing device 11 includes an input section 15 and a display section 16. The input section 15 is operated by a user to give an instruction to the printing device 11. The display section 16 displays various images. The display section 16 displays, for example, a menu screen, various types of message information, and the like.

The printing device 11 includes a supply cassette 17. The supply cassette 17 is provided in a lower portion of the main body 12. The supply cassette 17 is mounted in the main body 12 in a state of being insertable and removable. The supply cassette 17 is configured to be able to accommodate a plurality of media M such as paper. The supply cassette 17 supplies the accommodated medium M to a transport path in the main body 12. The printing device 11 includes a transport section 55 (refer to FIG. 2) that transports the medium M supplied from the supply cassette 17 along a transport path.

The printing device 11 includes a printing section 50. The printing section 50 performs printing on the medium M transported along the transport path using a recording material such as ink. The printing section 50 includes a carriage 51 that is movable in the width direction X1 that intersects the transport direction Y1 of the medium M, and a print head 52 that is provided at the lower portion of the carriage 51. The print head 52 prints on the medium M while the carriage 51 reciprocates in the width direction X1. The print head 52 may be a line type that is fixedly disposed at a position facing the transport path of the medium M.

The printing device 11 includes a discharge port 12A that opens on the front surface of the main body 12. The discharge port 12A discharges the medium M after printing. The printing device 11 includes a discharge tray 18 slidably provided in a front portion of the main body 12. The medium M after printing discharged from the discharge port 12A is stacked on the discharge tray 18.

The printing device 11 includes a plurality of recording material containers 53 that contain recording materials such as ink. The printing device 11 includes the same number of recording material containers 53 as the number of colors that can be printed on the medium M by the printing section 50. The recording material containers 53 individually contain recording materials such as inks of respective colors. The printing device 11 is a cartridge type in which the recording material container 53 is, for example, an ink cartridge that is replaceable.

The printing device 11 of the example illustrated in FIG. 3 is a so-called on-carriage type in which the recording material container 53 is mounted on a mounting portion (not illustrated) provided on the upper portion of the carriage 51. When the recording material such as ink in the recording material container 53 in the printing device 11 is in a near-end state or an end state, the user replaces the recording material container 53 with respect to the printing device 11. The user replaces the recording material container 53 with respect to the mounting portion in the upper portion of the carriage 51 which is exposed when the cover 14 is opened.

The printing device 11 may be a so-called off-carriage type in which the recording material container 53 is disposed at a predetermined position in the main body 12 different from the carriage 51. In the case of the off-carriage type, a cover provided at the front portion of the main body 12 is opened, and the recording material container 53 mounted on the mounting portion is replaced. In a case where the liquid supply source is a liquid cartridge such as an ink cartridge, the user needs to prepare, for example, a new recording material container 53 before the printing device 11 is in the near-end state or the end state.

Next, an electrical configuration and a functional configuration of the printing system 10 will be described with reference to FIG. 2. As illustrated in FIG. 2, the printing device 11 and the terminal device 20 are connected to each other so as to be able to communicate with each other via a home network HNW such as a LAN. The communication of the home network HNW may be wireless communication such as Wi-Fi (registered trademark) or wired communication. Alternatively, the communication section may be a short-range wireless communication section such as a Bluetooth (registered trademark) communication section or an infrared communication section. The home network HNW is connected to a network NW such as the internet.

The terminal device 20 is communicably connected to the servers 30 and 40 via the networks HNW and NW. The printing device 11 can communicate within the range of the home network HNW, but may be communicably connected to the servers 30 and 40 via the networks HNW and NW.

The printing device 11 includes a communication section 19, a control section 60, an input section 15, a display section 16, an image reading section 13, and a printing section 50. The printing section 50 includes a print head 52, a transport section 55, and a maintenance section 56.

The control section 60 includes a computer 61. The computer 61 includes a CPU and a memory section 62. The control section 60 is not limited to a control section that performs software processing for all processes executed by the control section 60. For example, the control section 60 may include a dedicated hardware circuit (for example, an application specific integrated circuit: ASIC) that performs hardware processing for at least a part of the processing executed by the control section 60. That is, the control section 60 can be configured as a circuit (circuitry) including one or more processors that operate according to a computer program (software), one or more dedicated hardware circuits that execute at least a part of various processes, or a combination thereof. The processor includes a CPU and a memory section 62 (memory) such as a RAM and a ROM. The memory section 62 stores program codes or instructions configured to cause the CPU to execute processing. The memory, that is, a computer-readable medium, includes any available medium that can be accessed by a general purpose or special purpose computer.

The computer 61 includes a print control section 63 and a recording material consumption amount measurement section 64 as functional sections by executing a program stored in the memory section 62.

The print control section 63 controls the printing section 50. The printing device 11 performs printing based on the print data received from the terminal device 20. The print control section 63 controls the print head 52 and the transport section 55 based on the print data to print a character or an image on the medium M. The print control section 63 controls the maintenance section 56 to perform maintenance on the print head 52. In the ink jet type printing device 11, as the maintenance, cleaning or the like for removing foreign matters such as thickened ink in the nozzles or bubbles in the ink is performed by forcibly discharging the ink from the nozzles of the print head 52. The print head 52 consumes the recording material by printing and maintenance.

The control section 60 can communicate with a storage element (not shown) provided in the recording material container 53 mounted on the carriage 51. When the printing device 11 is powered on, the control section 60 reads the recording material information RI from each memory element of the plurality of recording material containers 53 and stores the recording material information RI in the memory section 62. The recording material information RI is information relating to the recording material for each recording material container 53. The recording material information RI may include amount information relating to the amount of the recording material for each recording material container 53. The amount information may be a remaining amount or a consumption amount as long as the amount of the recording material in the recording material container 53 can be specified. In the present embodiment, remaining amount information, which is information on the remaining amount, is adopted as an example of the amount information. That is, the recording material information RI may include information on the remaining amount of the recording material. The recording material information RI may include color information, expiration date, product number information, and the like of the recording material for each recording material container 53.

The recording material consumption amount measurement section 64 measures the recording material consumption amount by the print head 52. The recording material consumption amount measurement section 64 updates the data of the recording material remaining amount by subtracting the recording material consumption amount from the recording material remaining amount in the recording material information RI. When the printing device 11 is powered off, the control section 60 writes the recording material information RI including the latest recording material remaining amount stored in the memory section 62 into the storage element of the recording material container 53. When the printing device 11 is powered on next time, the control section 60 can read the recording material information RI including the latest recording material remaining amount at the time of the previous power-off from each storage element of the plurality of recording material containers 53.

The terminal device 20 functions as the print control device 70 by installing the print driver program and the printing-related application program. The terminal device 20 includes a print control device 70 that gives a print instruction to the printing device 11. The terminal device 20 includes a computer 71 and a memory section. The computer 71 functions as a print driver 72 by executing a print driver program stored in the memory section. The computer 71 functions as an image generation section 73 by executing the printing-related application program. The print control device 70 included in the terminal device 20 includes a print driver 72 and an image generation section 73 configured by software.

In the present embodiment, the terminal device 20 includes the image generation section 73, but the printing device 11 may include an image generation section 65 illustrated by two dot chain line in FIG. 2 having the same function as the image generation section 73. In FIG. 2, in order to distinguish the two, the print control device 70 side is referred to as a first image generation section 73, and the printing device 11 side is referred to as a second image generation section 65. In the present embodiment, as an example, the generative AI module 31 is caused to generate an image using the image generation section 73 included in the terminal device 20. In the printing device 11 or the like located at the bottom in FIG. 1 directly connected to the network NW, the second image generation section 65 on the printing device 11 side may cause the generative AI module 31 to generate an image.

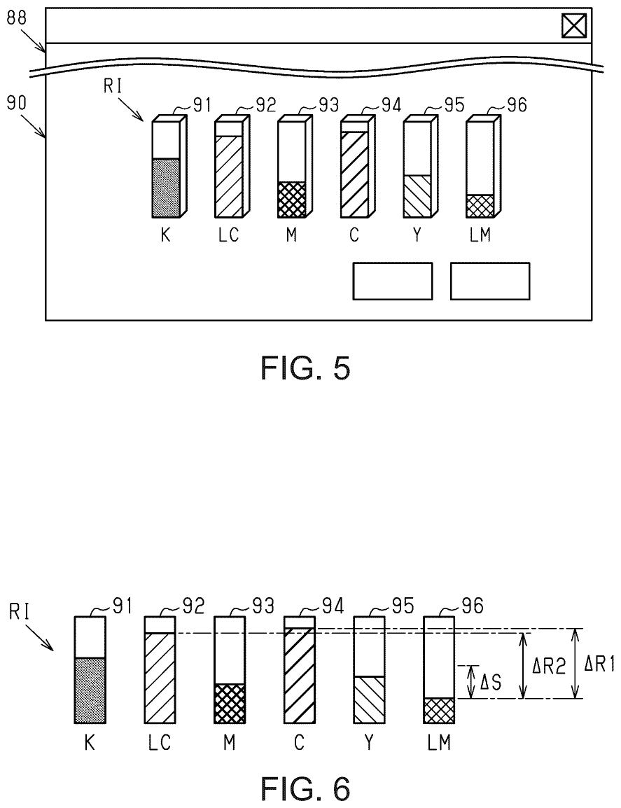

The print driver 72 controls the printing device 11. The terminal device 20 stores application programs such as a document creation application, a spreadsheet application, and a presentation creation application in the memory section as other applications that do not belong to the print control device 70. These applications are used by a user when creating documents, tables, graphs, presentation documents (hereinafter also referred to as “presentation documents”), and the like, and also when printing the created materials. When the user gives a print instruction by operating the input section 21, each of these applications calls up the print driver 72. The called print driver 72 displays a printing condition setting screen 88 on which the print condition information can be selected, and the recording material information RI acquired by communicating with the printing device 11 (refer to FIG. 5 for both) on the display section 22. The user selects the print condition information as necessary by operating the input section 21 of the terminal device 20, and then instructs the execution of printing.

The print driver 72 generates print data including a print command based on any data of a document, a table, a graph, and presentation material for which execution of printing is instructed. The print data includes print image data including dot data for each color of the recording material. The dot data may be gradation data of a predetermined gradation within a range of 2 to 4 gradations. The print driver 72 transmits the generated print data to the printing device 11.

The recording material consumption amount measurement section 64 may measure the consumption amount of the recording material consumed by the print head 52 in printing by counting the number of dots of the print image data. When the print image data is data including a plurality of types of dots having different dot sizes, the recording material consumption amount measurement section 64 may measure the recording material consumption amount for each color by accumulating values obtained by multiplying the count value for each dot size according to the gradation value by a coefficient according to the dot size.

The print control device 70 included in the terminal device 20 includes the first image generation section 73 described above. The first image generation section 73 includes an acquisition section 81, an instruction section 82, and a receiving section 83. The first image generation section 73 may further include a prompt generation section 84. The prompt generation section 84 may include a comparison section 85 that compares the remaining amounts of a plurality of recording materials.

The acquisition section 81 acquires the recording material information RI relating to a plurality of types of recording materials having different colors. The recording material information RI is information relating to a plurality of types of recording materials including a first recording material of which the color is a first color and a second recording material, which is a recording material of a second color that is a color different from the first color. The plurality of colors are, for example, four colors, six colors, eight colors, ten colors, and the like. The number of colors may be two or more, and may be two, three, five, seven, nine, or eleven or more. The plurality of types of recording materials may include different types of recording materials having the same color. The plurality of types of recording materials may include, for example, two types of ink, that is, dye ink and pigment ink of the same color. For example, two types of black printing materials (for example, black ink) of dye ink and pigment ink may be included.

In a case where the plurality of types of colors of the recording material are, for example, four colors, the colors include black (K), cyan (C), magenta (M), and yellow (Y). In the example shown in FIG. 2, the plurality of colors of the recording material are six colors. The six colors may include, for example, black (K), cyan (C), light cyan (LC), magenta (M), light magenta (LM), and yellow (Y).

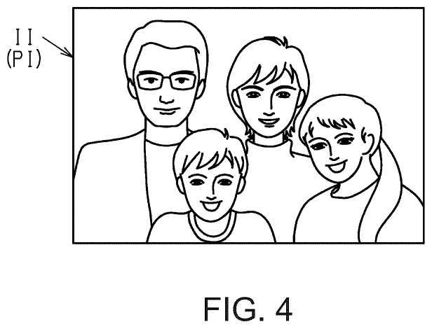

The first image generation section 73 may input a print image PI instructed to be printed by the user as the input image II (refer to FIG. 4). The acquisition section 81 may acquire the recording material information RI after the printing of the print image PI. The recording material information RI acquired after the printing of the print image PI is more up-to-date information than the recording material information RI acquired before the printing.

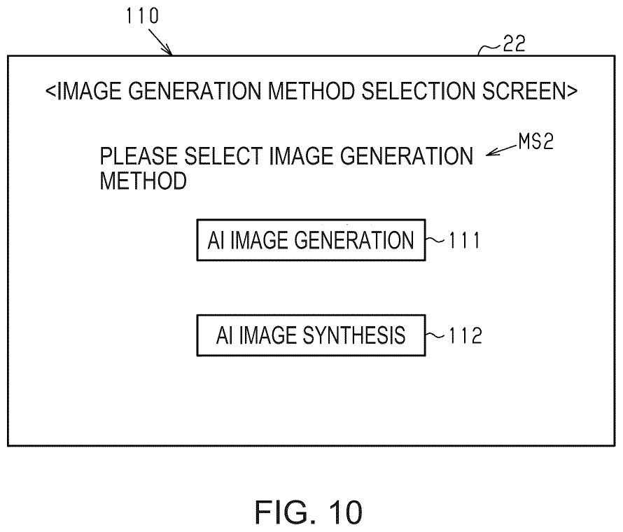

The instruction section 82 causes the generative AI module 31 to generate an image based on the recording material information RI. In addition to the recording material information RI, the instruction section 82 may cause the generative AI module 31 to generate an image based on the input image information IS including the input image II (for example, refer to FIG. 4). In addition to the recording material information RI, the instruction section 82 may cause the generative AI module 31 to generate an image based on information (for example, text information) including a prompt that was input by the user. The input image information IS may include a prompt consisting of text information in addition to the input image II. The instruction section 82 may cause the display section 22 to display an input screen (refer to FIGS. 10 to 12) for prompting the user to select or input information necessary for generating a prompt. Further, in addition to the recording material information RI, the instruction section 82 may cause the generative AI module 31 to generate an image based on color information of the medium M, which is a printing target. The color information may include, for example, the color of the surface of the medium M before printing. The surface of the medium M may include a pattern. The color of the surface including the pattern may be a plurality of two or more colors. Examples of the medium M include paper sheets, cardboard, envelopes, writing paper, letter paper, and OHP films (synthetic resin films). Details of various screens including the input screen that the first image generation section 73 caused to be displayed on the display section 22 of the terminal device 20 will be described later.

The instruction section 82 may generate a prompt using the prompt generation section 84. The prompt generation section 84 generates a prompt, which is an image generation command, based on the recording material information RI. The generated prompt may include the input image information IS used by the instruction section 82 for the instruction. The prompt may be only the recording material information RI or a part thereof, or may alternatively or additionally include information derived from the recording material information RI or a part thereof.

The prompt generation section 84 may include a comparison section 85. The comparison section 85 compares the amounts relating to the plurality of recording materials based on the recording material information RI. The comparison section 85 may compare the amounts of a plurality of recording materials that can be used for printing by the printing section 50. For example, the comparison section 85 may compare the amounts of recording materials in a plurality of recording material containers 53 that supply a plurality of recording materials to the printing section 50. The comparison of the amounts by the comparison section 85 may be comparison of the amounts themselves such as the consumption amount and the remaining amount of the recording material, or may be comparison of the amounts indirectly by comparing amount specifying information capable of indirectly specifying the amounts such as the consumption amount and the remaining amount. As an example, the comparison section 85 may compare the remaining amounts of a plurality of recording materials. The comparison of the remaining amounts is not limited to the comparison of the remaining amounts themselves, and the remaining amounts may be indirectly compared by the comparison of the remaining amount specifying information.

The comparison section 85 compares the amounts of the plurality of recording materials to select a consumption color that is the color of the main recording material to be consumed when the generated image GI is printed. The comparison section 85 may select a consumption color by comparing the remaining amounts of a plurality of recording materials. That is, the comparison section 85 may include a consumption color selection section that selects a main consumption color from among the colors of the plurality of recording materials based on the comparison result of the remaining amounts. The number of recording materials to be compared when the comparison section 85 selects the consumption color may be all of the plurality of recording materials or may be a part of two or more of the plurality of recording materials. The comparison section 85 may select the one color having the largest remaining amount of the recording material as the consumption color. The comparison section 85 may compare the amounts relating to the plurality of recording materials using a threshold value. The comparison process in which the comparison section 85 selects the consumption color using the threshold value will be described in detail later.

The receiving section 83 receives the generated image GI generated by the generative AI module 31. The receiving section 83 may cause the display section 22 to display the received generated image GI.

The print control device 70 may further include an image transmission section 86. The image transmission section 86 transmits the generated image GI received by the receiving section 83 to the printing device 11 that performs printing using a recording material. The image transmission section 86 may be a transmission function section that transmits the print data to the printing device 11 after the print driver 72 converts the print image PI to be printed into the print data that can be printed, or may be provided separately from the print driver 72. In the latter case, the generated image GI transmitted by the image transmission section 86 may be converted into print data that can be printed by the control section 60 of the printing device 11.

In this manner, the first image generation section 73 causes the generative AI module 31 to generate the generated image GI according to the image generation command (prompt) based on the acquired recording material information RI, and causes the printing section 50 to print the generated image GI.

The printing section 50 prints the received generated image GI using recording material. The printing device 11 receives the print data of the generated image GI from the image transmission section 86 (the print driver 72). The control section 60 of the printing device 11 controls the printing section 50 based on the received print data to print the generated image GI on the medium M. The control section 60 controls the print head 52 based on the print image data of the generated image GI included in the print data. The printing section 50 prioritizes consumption of the recording material of the consumption color by the print head 52 ejecting the recording material (ink) of the colors necessary for printing the color generated image GI.

As illustrated in FIG. 2, the second image generation section 65 on the printing device 11 side may include the acquisition section 81, the instruction section 82, and the receiving section 83, similarly to the first image generation section 73. The second image generation section 65 may include a prompt generation section 84. The prompt generation section 84 may include a comparison section 85. The second image generation section 65 may cause the display section 16 to display a necessary display, or may cause the display section 22 of the terminal device 20 via the network HNW.

### Generative AI Module 31

Next, the generative AI module 31 will be described. The generative AI module 31 provided by the server 30 may include the following. Examples of the image generation AI tool include “ChatGPT” of OpenAI Corporation, “DALL-E” (for example, DALL E3), which is an image generation AI tool of OpenAI Corporation, “Gemini” of Google Inc., “Midjourney” of Midjourney Inc., and “Stable Diffusion” of Stability AI Inc. Alternatively, it may be “DeepArt”, “PICSOROBAN (PICSORO)”, “Adobe Firefly”, “MyEdit”, “Bing Image Creator”, “Canva”, “Novel AI”, “AI Picasso”, “StableStudio”, “Generative Adversarial Network (GAN)”, “Variational Auto-Encoder (VAE)”, or the like. Further, the generative AI module 31 may be “Gamma”, “Napkin AI”, or the like, which are material generation AI. The generative AI module 31 is equipped with, for example, a large language model (LLM). The large language model includes a learned model such as a generative pre-trained transformer (GPT). The large language model may include a transformer mechanism.

The second server 40 is a generative AI service providing server having a generative AI service provider module 41. The second server 40 may provide the generated AI service to the user by using an application programming interface (API) provided by a provider of the generative AI module 31. Examples of the API include an API of ChatGPT, an API of Gemini, and the like. The second server 40 is a server that provides at least an application for image generation (hereinafter, also simply referred to as an “application”) to a user of the printing device 11. For example, the user downloads the application from the second server 40 to the terminal device 20 of the user. The user can use the AI image generation service provided by the second server 40 by activating the application in the terminal device 20. The application may be incorporated in the print driver 72 or may include a mechanism that operates in cooperation with the print driver 72. In this way, the first image generation section 73 including software is configured in the terminal device 20 to which the application is downloaded. The generative AI service provider module 41 provides a user request that was received from the terminal device 20 via the application to the generative AI module 31 of the first server 30 via the API. The image generation section 73 in the terminal device 20 may directly access the generative AI module 31 of the first server 30 without the second server 40 to generate the image GI.

### Input Image II as Print Image PI

The image shown in FIG. 4 is a print image PI which is an image to be printed by the user. In the present embodiment, an image input by the print control device 70 of the terminal device 20 is referred to as an input image II. The input image II includes a print image PI input for the purpose of printing by the print driver 72 and a generation AI input image input for the purpose of AI image generation by the image generation section 73.

The input image II illustrated in FIG. 4 is displayed on the display section 22 of the terminal device 20. When the user operates the input section 21 to print the input image II as the print image PI, for example, when the user selects printing on the image display application, the print driver 72 is called up. The input image II illustrated in FIG. 4 is, for example, a family photo. As a result of printing the print image PI of the family photo, the remaining amount of the plurality of recording materials based on the latest recording material information RI is in a state illustrated in FIG. 5.

### Recording Material Information RI and Screen Display Thereof

When the print driver 72 is activated, the print driver 72 acquires the recording material information RI from the printing device 11 and determines the presence or absence of recording material in a near-end state or an end state. When there is in a near-end state or an end state of the recording material, the print driver 72 notifies the user by displaying, on the remaining amount notification screen 90 illustrated in FIG. 5, information indicating that the recording material is in a near-end state or an end state.

The print driver 72 was called up by printing having been selected on the image display application, which displays the print image PI illustrated in FIG. 4, and displays a printing condition setting screen 88 illustrated in FIG. 5 on the display section 22. The remaining amount notification screen 90 illustrated in FIG. 5 may be included in a part of the printing condition setting screen 88, or may be displayed on another screen such as a pop-up when an ink remaining amount button (not shown) in the printing condition setting screen 88 is selected. In the printing condition setting screen 88, printing condition information such as a medium size, a type of medium (medium type), a printing color (color/monochrome), and printing quality (printing resolution) can be set by a selection operation.

The print driver 72 generates the remaining amount notification screen 90 illustrated in FIG. 5 based on the recording material information RI, and displays the remaining amount notification screen 90 on the display section 22. The remaining amount notification screen 90 includes a plurality of remaining amount scales 91 to 96 that simulate columnar containers that store the remaining amounts of a plurality of recording materials for respective colors. The user can visually check the remaining amounts of the plurality of recording materials by the plurality of remaining amount scales 91 to 96.

When even one of the plurality of recording materials is equal to or less than a near-end threshold value, the user can visually check the recording material of the near-end state from the remaining amount notification screen 90. The plurality of remaining amount scales 91 to 96 illustrated in FIG. 5 reflect the remaining amount information indicating the remaining amount of each recording material among the recording material information RI, and thus are one type of the recording material information RI. The display section 16 of the printing device 11 may also display the plurality of remaining amount scales 91 to 96 and the information on the recording material in a near-end state. The recording material information RI in the present embodiment is not limited to the data of the recording material information RI stored in the memory section 62. The recording material information RI may include image information related to the plurality of remaining amount scales 91 to 96 generated based on the recording material information RI, and notification information related to the near-end state and the end state. The recording material information RI does not need to be information on all of the plurality of recording materials, and may be information on recording materials of two or more colors among the plurality of recording materials. Further, the recording material information RI may include amount specifying information capable of directly or indirectly specifying the amount such as the remaining amount of two or more recording materials among the plurality of recording materials.

In FIG. 5, remaining amount scales 91 to 96 of the respective colors of black (B), light cyan (LC), magenta (M), cyan (C), yellow (Y), and light magenta (LM) are displayed. In the example shown in FIG. 5, the remaining amount of cyan (C) is the largest, and the remaining amount of light cyan (LC) is the second largest. The remaining amount of light magenta (LM) is the smallest, and the remaining amount of magenta (M) is the second smallest. The remaining amount of black (K) and the remaining amount of yellow (Y) are intermediate remaining amounts.

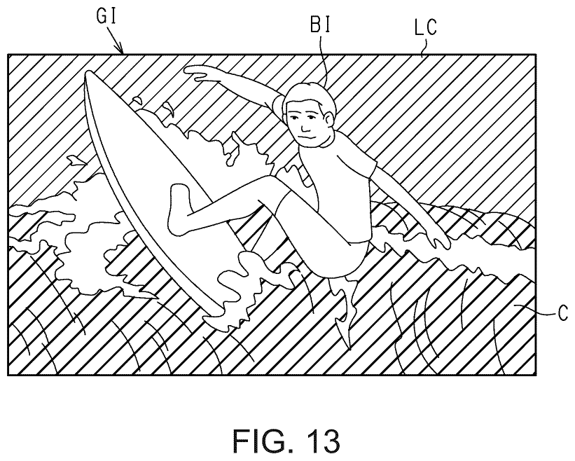

In the example illustrated in FIG. 5, it is understood that a good amount of recording materials of cyan (C) and light cyan (LC) remain, and that the recording materials of magenta (M) and light magenta (LM) are insufficient. Here, if the user repeats printing without considering anything, there is a possibility that only the replacement timing of the magenta recording material container 53 comes earlier. Therefore, in the present embodiment, the generative AI module 31 is caused to generate an image GI (refer to FIG. 13) of a color arrangement capable of reducing the variation in the remaining amount based on the recording material information RI in consideration of the remaining amount state. When the user likes the generated image GI and selects the printing thereof, the recording material of the specific consumption color is consumed more by the print head 52 that prints the generated image GI. This reduces the variation in the remaining amount of the recording material. Details of the process and processing for generating an image by the generative AI module 31 will be described later.

### Comparison Process by Comparison Section 85

Next, a comparison process in which the comparison section 85 compares the remaining amounts of a plurality of recording materials will be described with reference to FIGS. 6 to 8. The comparison section 85 compares the remaining amounts of the plurality of recording materials based on the recording material information RI illustrated in FIG. 6. Based on the comparison result, the comparison section 85 selects a consumption color, which is a color of the recording material to be consumed in order to reduce the variation in the remaining amount. This comparison process may be performed using a threshold value. That is, the consumption color selection condition for selecting the consumption color from a plurality of colors (for example, six colors), which are the colors of a plurality of recording materials, may be a condition including a threshold value. In the present embodiment, the comparison section 85 may select the consumption color from a plurality of colors (for example, five colors) excluding black (K). Specifically, the comparison section 85 may select a consumption color that satisfies the consumption color selection condition from among cyan, magenta, yellow, light cyan, and light magenta belonging to a plurality of color recording materials.

The color of the recording material having the largest remaining amount may be selected as the consumption color. The comparison section 85 may select, as the consumption color, the color of the recording material with the remaining amount that exceeds the threshold value. The threshold value may also be changed depending on a minimum remaining amount, which is the smallest remaining amount of the plurality of recording materials.

The threshold value may change according to the difference ΔS of the remaining amount with respect to the minimum remaining amount. A color recording material may be set as a consumption color when it satisfies a condition of a remaining amount difference ΔRn equal to or larger than a predetermined difference ΔS, wherein the remaining amount difference ΔRn is a difference from a minimum remaining amount among remaining amounts of a plurality of recording materials. In this case, the threshold value is a value of the remaining amount obtained by adding the difference ΔS to the minimum remaining amount. In this way, the color of the recording material having a remaining amount exceeding the threshold value determined from the consumption color selection condition may be selected as the consumption color.

In the example shown in FIG. 6, cyan (C), which has the largest remaining amount difference ΔR1, and light cyan (LC), which has the second largest remaining amount difference ΔR2, are selected as the consumption colors. All the colors of the recording materials satisfying the above conditions may be set as the consumption colors. Further, as a condition for determining the consumption color, only the top one color or up to the top two colors may be determined in descending order of the remaining amount difference ΔRn. The consumption color selection condition may include a condition that a color of a recording material whose remaining amount is equal to or less than a lower limit threshold value is not selected as a consumption color.

In this way, after the printing of the print image PI which is the input image II, the printing of the generated image GI in which the recording material of the selected consumption color is mainly consumed is performed according to the selection of the user.

The instruction section 82 may generate the color generated image GI in a color arrangement in which the most recording material that is in the consumption color selected based on the remaining amount information in the recording material information RI is consumed.

The recording material of the selected one or more consumption colors is mainly consumed in the printing of the generated image GI. When a plurality of consumption colors are selected, the instruction section 82 may give an instruction to generate the image GI in a color arrangement in which the ratio of the consumption amounts of the recording materials of the plurality of consumption colors can be determined according to the ratio of the remaining amount differences ΔRn to the minimum remaining amounts of the recording materials of the plurality of consumption colors or according to the ratio of the remaining amounts Rn of the recording materials of the plurality of consumption colors. In a case where the consumption colors selected based on the recording material information RI are N colors (here, N is a natural number), the instruction section 82 may generate the generated image GI of the color with the color arrangement in which the consumption ratio of the recording materials of the N colors consumed during the printing is 1/(N+1) or more. For example, when the consumption color is a single color, the instruction section 82 generates the generated image GI with a color arrangement in which the consumption ratio of the recording material of the consumption color, which is a single color, is equal to or greater than ½. In a case where the consumption color is, for example, two colors, the instruction section 82 generates the generated image GI with a color arrangement in which the consumption ratio of each of the recording materials of the consumption color, which is two colors, is equal to or greater than ⅓.

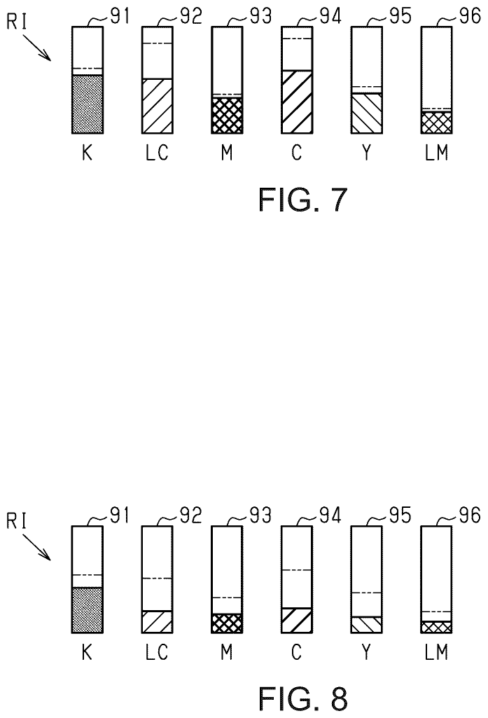

FIGS. 7 and 8 illustrate the remaining amount of a plurality of recording materials after the generated image GI is printed one or more times from the recording material information RI illustrated in FIG. 6. The remaining amount indicated by two dot chain line in FIG. 7 indicates the remaining amount in FIG. 6, and the remaining amount indicated by two dot chain line in FIG. 8 indicates the remaining amount in FIG. 7. By additionally printing the generated image GI that the user likes from the remaining amount illustrated in FIG. 6, the recording materials of the two colors of cyan (C) and light cyan (LC), which are the consumption colors, are consumed more than the consumption amounts of the recording materials of the other colors as illustrated in FIG. 7. Therefore, the variation in the remaining amount of the plurality of recording materials is smaller than that in FIG. 6. Further, from the remaining amount shown in FIG. 7, when the user prints the generated image GI one or more times, as shown in FIG. 8, the recording materials of two colors of cyan (C) and light cyan (LC), which are consumption colors, are consumed more than the consumption amounts of the recording materials of the other colors. In this manner, each time the user prints the generated image GI based on the recording material information RI, the variation in the remaining amount of the recording materials of the plurality of colors gradually decreases. As a result, for example, the frequency of the recording materials of five colors entering a near-end state or an end state at the same time increases. In the example shown in FIG. 8, five recording material containers 53 for five colors can be replaced all at once. The number of recording material containers 53 that can be replaced all at once may be two, three, or four.

In a case where printing is started from a state where the plurality of recording material containers 53 are not used, such as at the time of the initial operation of the printing device 11, there is a case where a recording material of a specific color among the plurality of recording materials is excessively consumed in normal printing. In this case, if normal printing is executed immediately before the near-end state, only the recording material of one color is in the near-end state, and thus the replacement timings of the plurality of recording material containers 53 may not overlap. In contrast, in a case where printing is started from a state where the plurality of recording material containers 53 are unused as in the initial operation, by printing generated images GI based on the recording material information RI a plurality of times, the plurality of recording materials are consumed in a state where the variation in the remaining amount is suppressed. Therefore, the number of times of printing until the near-end state occurs first can be increased. In other words, after the user purchases the printing device 11 and starts printing, the number of times printing can be performed before the recording material container 53 is replaced for the first time can be increased. As a result, more printing experiences can be executed without being interrupted by replacement of the recording material container 53.

In the present embodiment, the consumption color is selected from among a plurality of colors excluding black, for example, for the following reason. The black recording material is frequently used for printing of text such as documents. The printing device 11 cannot perform color printing when the recording material container 53 of even one color among the plurality of colors entered an end state. The printing device 11 can perform monochrome printing using a black recording material even when color printing cannot be performed due to one color of colors entering an end state. Therefore, in order to perform color printing, it is necessary to replace the recording material container 53 that is at end state. At this time, if the other recording material containers 53 are also at a near-end state or an end state, a plurality of recording material containers 53 can be replaced at a time. On the other hand, when the black recording material has entered an end state, monochrome printing can be performed with black obtained by mixing three colors, for example, cyan, magenta, and yellow. Therefore, even when the black recording material has entered an end state, the black recording material container 53 does not necessarily need to be replaced. Monochrome printing of text such as a document may be executed during photographic printing as in the present embodiment. In such a case, only the black recording material is consumed, and therefore, even when there is a large difference in remaining amount from the other recording materials before monochrome printing, there is a possibility that the difference in remaining amount will disappear. For this reason, in the present embodiment, the black recording material is not actively consumed, and the generated image GI is printed in a plurality of colors recording materials, thereby reducing the variation in the remaining amount of the recording material. This increases the frequency of the end state or near-end state of a plurality of color recording material containers 53 at a time.

### Various Screens Displayed on Display Section 22

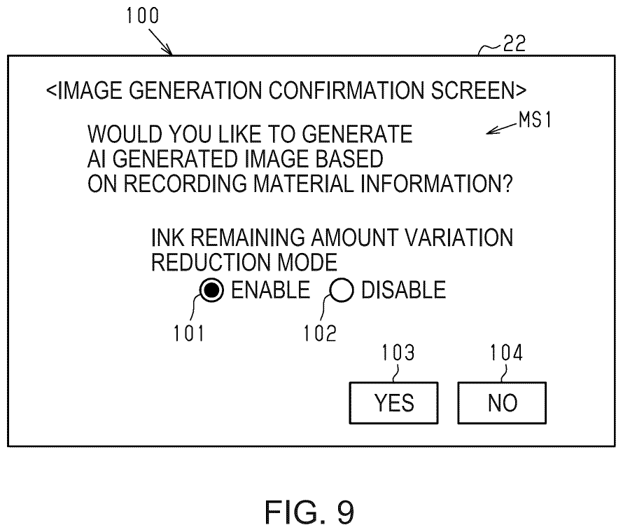

Next, various screens displayed on the display section 22 in generating the generated image GI will be described with reference to FIGS. 9 to 12.

FIG. 9 is an image generation confirmation screen 100. The image generation section 73 causes the display section 22 to display the image generation confirmation screen 100 at a timing when the user prints the print image PI. The display section 22 displays an image generation confirmation screen 100 for confirming permission of image generation based on the recording material information RI. The image generation confirmation screen 100 is displayed based on a user's operation related to printing.

As illustrated in FIG. 9, the image generation confirmation screen 100 includes a message MS1 for checking whether or not to generate an AI generated image based on the recording material information RI, and options 101 and 102 for selecting whether to enable or disable the ink remaining amount variation reduction mode (recording material remaining amount variation reduction mode). For example, a state in which the enable option 101 is selected may be a default. The comparison section 85 may perform the above-described comparison process before the image generation confirmation screen 100 is displayed. Then, as a result of the comparison process, when one or more consumption colors are selected and the execution condition of the ink remaining amount variation reduction mode is satisfied, the image generation section 73 may display the image generation confirmation screen 100 in a state where the enable option 101 is selected. The user who wants to disable the ink remaining amount variation reduction mode selects the disable option 102 by operating the input section 21. A user who desires to generate an AI image selects a YES button 103, and a user who does not desire to generate an AI image selects a NO button 104. The image generation section 73 that has received the selection of the YES button 103 shifts to the AI image generation mode. The image generation section 73 stores whether the ink remaining amount variation reduction mode is enable or disable in the memory.

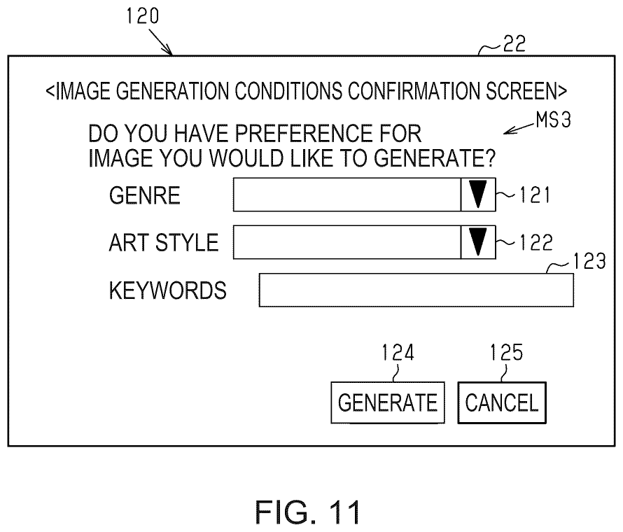

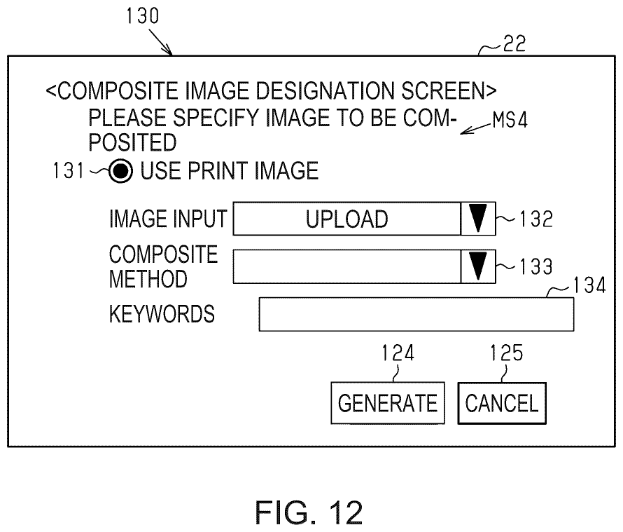

FIG. 10 shows an image generation method selection screen 110. The user can select one of two types of image generation methods. The image generation method selection screen 110 includes a message MS2 for prompting the user to select an image generation method and selection buttons 111 and 112 for selecting an image generation method. The selection button 111 is a button for selecting “AI image generation” for generating an AI image using the print image PI as the input image II. The selection button 112 is a button for selecting “AI image synthesis” for generating an AI image by designating an image such as a desired photograph uploaded by the user. When the image generation section 73 receives the selection of the selection button 111, the image generation section 73 displays an image generation condition confirmation screen 120 illustrated in FIG. 11 on the display section 22. On the other hand, when the selection of the selection button 112 is received, the display section 22 displays a composite image designation screen 130 illustrated in FIG. 12.

The image generation condition confirmation screen 120 shown in FIG. 11 has a message MS3 for prompting the user to input a desired condition if there is a desire for an image to be generated, an option 121 for selecting a genre, an option 122 for selecting an art style, and an input field 123 for inputting a keyword. In the input field 123, a text for instructing a request or the like for an image to be generated within the limit number of characters can be input in addition to the keyword. The image generation condition confirmation screen 120 further includes a generate button 124 for instructing generation of an AI image and a cancel button 125 to be selected when canceling image generation.

The composite image designation screen 130 illustrated in FIG. 12 includes a message MS4 for prompting the user to designate (upload) an image to be composited, and an option 131 for selecting whether to use a print image. The composite image designation screen 130 further includes a selection button 132 that enables selection of inputting an image to be combined by uploading, a selection button 133 that enables selection of a combining method, and an input field 134 that enables input of a keyword. In the input field 134, a text within the limit number of characters can be input in addition to the keyword.

For example, it is assumed that the generate button 124 is selected after “nature” is selected as the genre, “photograph” is selected as the art style, and “sports” is selected as the keyword on the image generation condition confirmation screen 120 illustrated in FIG. 11.

### Prompt and Generated Image GI

The prompt generation section 84 shown in FIG. 2 includes, in the prompt, the input image information including the input image II which is the print image PI, in addition to the recording material information RI. Specifically, the prompt generation section 84 includes, as the recording material information RI, two consumption colors of “cyan” and “light cyan” selected by the comparison section 85 in the comparison process based on the recording material information RI in the prompt. Further, the prompt generation section 84 includes the input information of the genre “nature”, the art style “photograph”, and the keyword “sports” input by the user in the prompt. The prompt generation section 84 generates a prompt based on the print image PI, the consumption color, and the input information of the user. The prompt generation section 84 may detect a person or a face in the print image PI, and when the person or the face is detected, the prompt generation section 84 may include the instructions indicating that the person or the face is extracted in the prompt. The instruction section 82 causes the generative AI module 31 to generate the image GI based on the prompt generated by the prompt generation section 84. That is, the instruction section 82 instructs the generative AI module 31 to generate the image GI by transmitting the prompt generated by the prompt generation section 84 and the print image PI to the server 30.

FIG. 13 illustrates the generated image GI received by the receiving section 83 from the generative AI module 31. As shown in FIG. 13, the generated image GI is an image in the art style of a photograph in which the person BI in the print image PI, “Dad,” is enjoying “surfing” as a keyword for “sports“ in the ”ocean“ as the genre of ”nature.“ The generated image GI of the color is generated in which the recording materials of the two colors of ”cyan (C)“ and ”light cyan (LC)”, which are the consumption colors included as the recording material information RI in the prompt, are mainly consumed.

In this way, the generated image GI, which is a photograph of Dad surfing in the sea in the print image PI, which is the input image II, is displayed on the display section 22. The image generation section 73 confirms with the user whether to additionally print the generated image GI displayed on the display section 22 of the terminal device 20. Then, if the user looks at the photograph of the generated image GI and finds it interesting, the user prints the photograph, and a large amount of recording material of cyan and light cyan is consumed. As a result, the variation in the remaining amount of the plurality of recording materials is reduced, and the replacement frequency of the recording material container 53 can be reduced. It is possible to provide a user with a printing experience that has not been provided before. By learning whether or not the generated image GI is printed, the generated image GI in which printing is more likely to be selected by the user may be generated. The generated image GI may be a realistic image, or may be an illustration or a cartoon in which feature points (hair color or presence or absence of a beard) are colored. The generated image GI may be a moving image such as an animation. In this case, the user may select and print one or more generated images GI of the AI generated moving image.

### Confirmation Screen After AI Image Generation

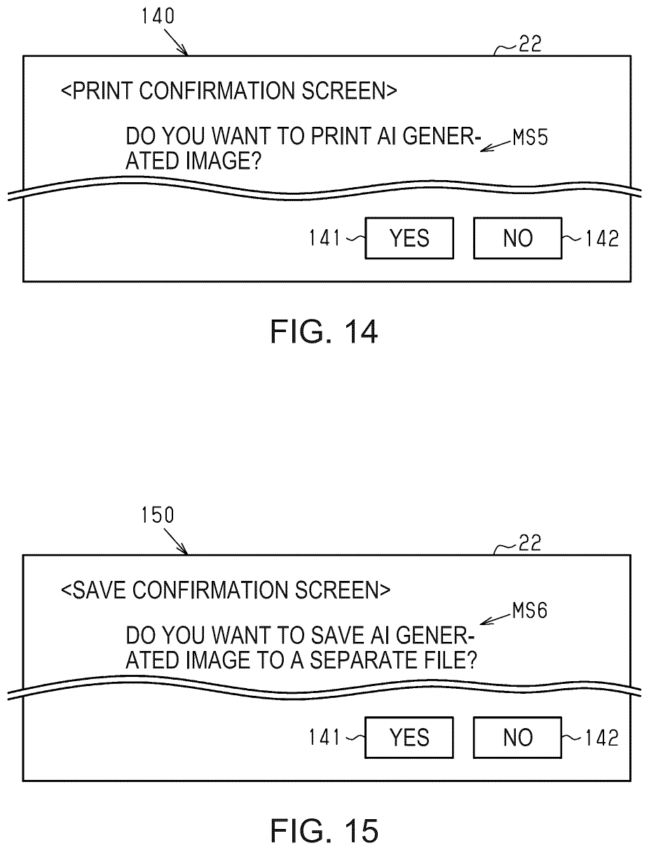

FIG. 14 illustrates a print confirmation screen 140. The display section 22 displays a print confirmation screen 140 for confirming the execution of printing of the generated image GI being displayed. The image generation section 73 confirms with the user whether or not to print the generated image GI illustrated in FIG. 13 displayed on the display section 22, through the print confirmation screen 140. The print confirmation screen 140 includes a message MS5 for confirming with the user whether or not to print the generated image GI, a YES button 141 to be selected when the user desires to print, and a NO button 142 to be selected when the user does not desire to print. When the image generation section 73 receives the selection of the YES button 141, the image generation section 73 notifies the image transmission section 86 of the reception of the printing. The image transmission section 86 transmits the generated image GI to the printing device 11. The image transmission section 86 converts the generated image GI into print data and then transmits the print data to the printing device 11, for example.

FIG. 15 illustrates a save confirmation screen 150. The image generation section 73 of the terminal device 20 may allow the user to select whether or not to save the generated image GI received by the receiving section 83 as a separate file. The image generation section 73 displays the save confirmation screen 150 on the display section 22 after the YES button 141 or the NO button 142 is selected on the print confirmation screen 140 illustrated in FIG. 14. The save confirmation screen 150 is a screen for confirming with the user whether or not to save the generated image GI shown in FIG. 13 displayed on the display section 22. The save confirmation screen 150 includes a message MS6 for checking with the user whether or not to save the generated image GI in another file, a YES button 141, and a NO button 142. The user who desires to save the generated image GI selects the YES button 141. On the other hand, a user who does not desire to save the generated image GI selects the NO button 142. When the image generation section 73 receives the selection of the YES button 141, the image generation section 73 saves the data of the generated image GI in the memory of the terminal device 20. When the image generation section 73 receives the selection of the NO button 142, the image generation section 73 closes the save confirmation screen 150.

### Operations of First Embodiment

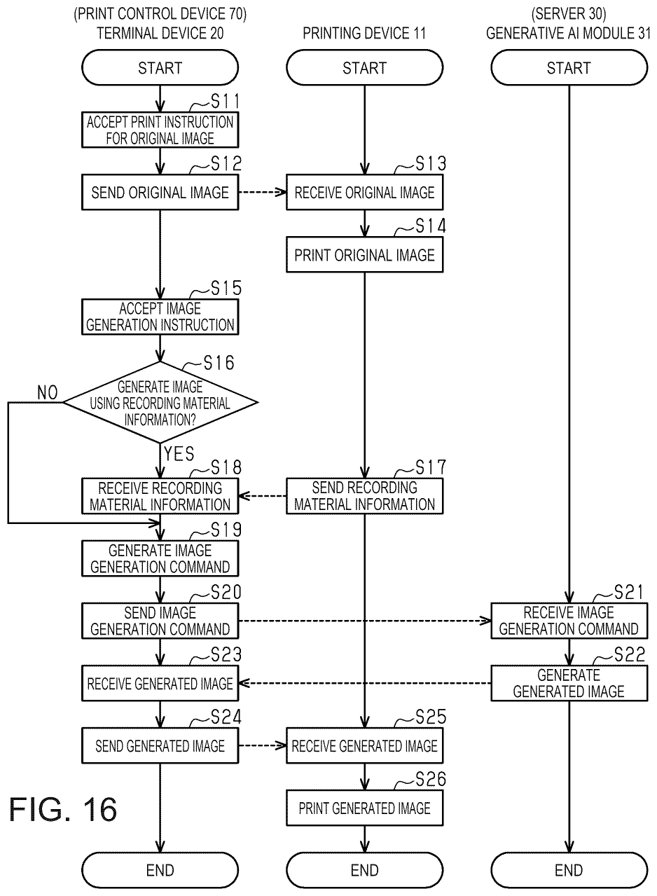

Next, the operation of the printing system 10 will be described with reference to FIGS. 1 to 16 and the like. In FIG. 16, the print image PI that is the source of the generated image GI is also referred to as an “original image”. The instruction by the prompt for causing the generative AI module 31 to generate the image GI is also referred to as an image generation command.

Hereinafter, an example of the recording material remaining amount variation reduction processing by the printing system 10 will be described with reference to FIG. 16.

First, when the user instructs the printing device 11 to perform printing from the terminal device 20, the print driver 72 and the application in the terminal device 20 are activated. When printing an image displayed on the display section 22 of the terminal device 20, the user selects printing on the application by operating the input section 21. The called-up print driver 72 displays a printing condition setting screen 88 illustrated in FIG. 5. The user who set the printing condition information in the printing condition setting screen 88 executes printing.

First, in step S11 in FIG. 16, the terminal device 20 receives an instruction to print an original image. The print driver 72 of the terminal device 20 converts the print image PI, which is the original image, into print data and transmits the print data to the printing device 11.

In step S12, the terminal device 20 transmits the original image to the printing device 11.

In step S13, the printing device 11 receives the original image.

In step S14, the printing device 11 prints the original image. The control section 60 of the printing device 11 controls the printing section 50 based on the print data in order to print, for example, the print image PI illustrated in FIG. 4 on the medium M.

In step S15, the terminal device 20 receives an instruction to generate an image. The image generation section 73 displays an image generation confirmation screen 100 illustrated in FIG. 9 on the terminal device 20 based on the operation related to printing by the user. The user who desires AI image generation selects the YES button 103. For example, the ink remaining amount variation mode is enabled.

In step S16, the terminal device 20 determines whether or not to generate an image using the recording material information RI. In a case where the ink remaining amount variation mode is enabled and the selection of the YES button 103 is received, it is determined that an image is generated using the recording material information RI, and the process proceeds to step S18. On the other hand, in a case where the remaining ink amount variation mode is disabled and the selection of the YES button 103 is received, and in a case where the selection of the NO button 104 is received, it is determined that the image generation using the recording material information RI is not performed, and the process proceeds to step S19.

In step S17, the printing device 11 transmits the recording material information RI. That is, when it is determined that the image generation is performed, the terminal device 20 requests the recording material information RI from the printing device 11. The printing device 11 that received the request transmits the recording material information RI to the terminal device 20. The recording material information RI is the latest recording material information RI after the printing of the original image is completed.

In step S18, the terminal device 20 receives the recording material information RI.

In step S19, the terminal device 20 generates an image generation command. The image generation section 73 of the terminal device 20 displays screens 110, 120, and 130 illustrated in FIGS. 10 to 12. The user selects or inputs necessary information on the screens 110, 120, and 130. On the image generation condition confirmation screen 120 shown in FIG. 11, a genre and a art style are selected, and a keyword is input. In addition, in the composite image designation screen 130 illustrated in FIG. 12, an image is uploaded or use of the print image PI is selected as necessary. The prompt generation section 84 generates a prompt based on the recording material information RI, the print image PI, and input information input by the user via the screens 120 and 130. The comparison section 85 selects a consumption color by performing a comparison process of comparing the remaining amounts of a plurality of recording materials based on the recording material information RI. In a case where an image is generated using the recording material information RI, the prompt may include the recording material information RI itself or information related to the consumption color and the remaining amount of the recording material of the consumption color obtained as a result of the comparison process from the recording material information RI.

In step S20, the terminal device 20 transmits an image generation command to the generative AI module 31. Specifically, the instruction section 82 transmits an image generation command by a prompt including the print image PI to the generative AI module 31 of the server 30. The terminal device 20 may transmit the image generation command to the generative AI module 31 of the server 30 via the generative AI service provider module 41 of the server 40.

In step S21, the generative AI module 31 receives an image generation command.

In step S22, the generative AI module 31 generates a generated image GI. Specifically, the generative AI module 31 generates the generated image GI based on the input image II and the image generation command including the prompt. In a case where the image generation is performed using the recording material information RI (affirmative determination in step S16), the image generation command includes information relating to the consumption color, and thus the generated image GI in which the main color is the consumption color is generated. For example, as illustrated in FIG. 13, a generated image GI having cyan (C) and light cyan (LC) as main consumption colors is generated. The generative AI module 31 transmits the generated image GI to the terminal device 20.

In step S23, the terminal device 20 receives the generated image GI. The terminal device 20 displays the generated image GI illustrated in FIG. 13 and displays a print confirmation screen 140 illustrated in FIG. 14. The user who desires printing operates the YES button 141 on the print confirmation screen 140.

In step S24, the terminal device 20 transmits the generated image GI to the printing device 11. That is, when the terminal device 20 receives an instruction to print the generated image GI based on the operation of the YES button 141, the terminal device 20 converts the generated image GI into print data and then transmits the print data to the printing device 11. The transmission of the generated image GI is performed by the image transmission section 86 in the terminal device 20.

In step S25, the printing device 11 receives the generated image GI.

In step S26, the printing device 11 prints the generated image GI. In a case where image generation is performed using the recording material information RI, the generated image GI illustrated in FIG. 13 is printed. By printing the generated image GI, the recording materials of cyan (C) and light cyan (LC), which are the consumption colors, are mainly consumed. In this way, the variation in the remaining amount of the plurality of recording materials is reduced by the user liking the image GI generated using the recording material information RI and additionally printing the print image PI. By repeatedly printing the generated image GI, the large variation in the remaining amount illustrated in FIG. 6 is reduced in a stepwise manner as illustrated in FIGS. 7 and 8. As a result, since the plurality of recording material containers 53 become the near-end state or the end state at the same time, the plurality of recording material containers 53 can be replaced at a time.

### Printing Method

The printing method of the present embodiment includes the following (A) to (C).

(A) Acquiring recording material information RI relating to a plurality of types of recording materials having different colors.

(B) Generating an image by the generative AI module 31 based on the recording material information RI.

(C) Printing the generated image GI generated by the generative AI module 31 using the recording material.

The processes of steps S17 and S18 in FIG. 16 corresponds to an example of the process of (A) described above. The process of step S22 corresponds to an example of the process of (B). Further, the process of step S26 corresponds to an example of the process of (C).

According to the present embodiment, the following effects are obtained.

(1-1) The printing system 10 includes the acquisition section 81, the instruction section 82, the receiving section 83, and the printing section 50. The acquisition section 81 acquires recording material information RI relating to a plurality of recording materials having different colors. The instruction section 82 causes the generative AI module 31 to generate an image based on the recording material information RI. The receiving section 83 receives the generated image generated by the generative AI module 31. The printing section 50 prints the received generated image GI using recording material. According to this configuration, since the color based on the recording material information RI related to the plurality of recording materials having different colors is reflected in the generated image GI, it is possible to effectively reduce the variation in the remaining amount of the recording material by printing the generated image GI.

(1-2) The instruction section 82 causes the generative AI module 31 to generate an image based on the input image information IS including the input image II in addition to the recording material information RI. According to this configuration, since the image GI in which the color based on the recording material information RI and the input image II are reflected is generated, the user is likely to increase the printing frequency of the generated image GI by being interested in the generated image GI.

(1-3) The instruction section 82 causes the generative AI module 31 to generate an image based on information including a prompt input by the user in addition to the recording material information RI. According to this configuration, the generative AI module 31 can generate an image desired by the user. Therefore, the frequency of printing the generated image GI by the user is increased, and thus, it is possible to effectively reduce the variation in the remaining amount of the recording material.

(1-4) The printing system 10 includes the display section 22 that displays the image generation confirmation screen 100 for confirming the permission of the image generation based on the recording material information RI.

According to this configuration, the user can permit the generation of the image only when the user desires the generation of the image, and thus it is possible to suppress a delay in printing of the input image II or the like due to unnecessary generation of the image.

(1-5) The printing system 10 includes the display section 22 that displays the generated image GI and displays the print confirmation screen 140 for confirming the execution of printing of the generated image GI. According to this configuration, the user can quickly execute printing when the user wants to print after confirming the displayed generated image GI.

(1-6) The printing system 10 further includes the prompt generation section 84 that generates a prompt, which is an image generation command, based on the recording material information RI. According to this configuration, the generated image GI can be generated in accordance with the image generation command by the prompt generated based on the recording material information RI.

(1-7) The prompt generation section 84 includes the comparison section 85 that compares the remaining amounts of the plurality of recording materials. According to this configuration, the color of the recording material to be reflected in the prompt can be specified by comparing the remaining amounts of the plurality of recording materials. Therefore, since the consumption of the recording material of the specified color is promoted by the printing of the generated image GI, it is possible to effectively reduce the variation in the remaining amount of the recording material.

(1-8) The input image II is a print image for which a print instruction is given, and the acquisition section 81 acquires the recording material information RI after the print image is printed. According to this configuration, since the image is generated based on the latest recording material information RI after the printing of the print image, it is possible to effectively reduce the variation in the remaining amount of the recording material.

(1-9) The image generation confirmation screen 100 is displayed based on the operation related to printing by the user. According to this configuration, since the generation confirmation screen can be displayed at an appropriate timing based on the operation related to printing by the user, it is difficult for the user to fail to confirm.

(1-10) The recording material information RI includes information on the remaining amount of the recording material. According to this configuration, since an image in which a color corresponding to the remaining amount information of the recording material is reflected can be generated, it is possible to reduce a variation in the remaining amount of the recording material by printing the generated image GI.

(1-11) Allow the user to select whether or not to save the generated image GI received by the receiving section 83 as a separate file. According to this configuration, the user can easily save the generated image GI that the user likes as a separate file.

(1-12) The instruction section 82 generates the generated image GI of the color in which the recording material of the consumption color selected based on the remaining amount information in the recording material information RI is consumed the most during the printing. According to this configuration, since the color corresponding to the remaining amount information of the recording material is consumed most by the printing of the generated image, it is possible to effectively reduce the variation in the remaining amount of the recording material.

(1-13) In a case where the number of colors of which the remaining amount according to the remaining amount information based on the recording material information RI is equal to or greater than the threshold value is N (here, N is a natural number), the instruction section 82 generates the generated image GI of a color in which the consumption ratio of the recording materials of N colors consumed during printing is equal to or greater than 1/(N+1). According to this configuration, since the color corresponding to the remaining amount information of the recording material is consumed most by the printing of the generated image, it is possible to effectively reduce the variation in the remaining amount of the recording material.

(1-14) The threshold value changes depending on the minimum remaining amount which is the smallest remaining amount among the plurality of recording materials. According to this configuration, it is possible to effectively reduce the variation in the remaining amount of the recording material by printing the generated image GI. For example, if the threshold value is a fixed value, the recording material may be excessively consumed even though the difference from the minimum remaining amount is small, or the consumption amount of the recording material may be excessively small even though the difference from the minimum remaining amount is large. The problem in the case where the threshold value is a fixed value can also be solved.

(1-15) The threshold value changes depending on a difference ΔS in remaining amount from a minimum remaining amount which is the smallest remaining amount among the plurality of recording materials. According to this configuration, it is possible to effectively reduce the variation in the remaining amount of the recording material by printing the generated image GI. In addition, the problem in the case where the threshold value is a fixed value can be solved.

(1-16) Since the consumption amount of the recording material of the specific color according to the amount of the recording material based on the recording material information RI can be greatly changed, the adjustment amount for reducing the variation in the remaining amount per the number of times of printing can be increased. The replacement frequency of the recording material container 53 per the number of times of printing can be reduced. The frequency of replacing a plurality of recording material containers 53 at a time is increased. For example, in a case where the printing device 11 is an ink jet type, the initial filling is performed every time the recording material container 53 is replaced. In the initial filling, the flow path from the supply port of the recording material container 53 to the nozzles of the print head 52 is filled with new ink, thereby removing air entering at the time of replacement from the ink in the flow path. In the initial filling, the same amount of ink is consumed from the non-replaced ink cartridges other than the replaced ink cartridge. Therefore, it is preferable that the replacement frequency of the recording material container 53 is low in order to suppress the consumption of the ink for purposes other than printing. According to the present embodiment, since the variation in the remaining amount of the recording material can be effectively reduced, the frequency of synchronizing the replacement times of two or more recording material containers 53 is increased. That is, the replacement frequency of the recording material container 53 per the number of times of printing can be reduced. Therefore, it is possible to suppress consumption of the recording material due to the initial filling accompanying the replacement of the recording material container 53. Furthermore, the number of times of printing until the near-end state occurs for the first time after the initial operation of the printing device 11 in which printing is started from a state where the plurality of recording material containers 53 are unused can be increased. Therefore, more printing experiences including printing of the generated image GI can be realized without being interrupted by replacement of the recording material container 53.

(1-17) An image suitable for a specification corresponding to the number of colors (four colors, six colors, or the like) that can be supported by the printing device 11 can be generated. Accordingly, compared to the printing device described in JP-A-2004-93817, it is possible to reduce a difference in sharpness between an image displayed on the display section 22 of the terminal device 20 such as a smartphone and an image to be actually printed.

(1-18) The instruction section 82 may cause the generative AI module 31 to generate an image based on color information of the medium M to be printed in addition to the recording material information RI. The color information is information indicating the color of the medium M before printing. The color information may include information related to the color of the surface of the medium M. According to this configuration, it is possible to reduce the inconvenience that the outline or the like of the printed generated image GI is likely to be unclear due to the generated image GI being printed on the medium M with the color scheme of the same color or the approximate color as the color of the medium M. That is, since the color arrangement of the generated image GI accompanied by the consumption of the recording material of the consumption color based on the recording material information RI is determined by the contrast with the color of the medium M, it is possible to cause the generative AI module 31 to generate the generated image GI having a clear outline when printed on the medium M. Therefore, it is possible to reduce the variation in the remaining amount of the recording material, and to print the generated image GI with a clear outline on the medium M.

(1-19) The print control device 70 provided in the terminal device 20 for giving a print instruction to the printing device 11 includes the acquisition section 81, the instruction section 82, the receiving section 83, and the image transmission section 86. The acquisition section 81 acquires the recording material information RI relating to a plurality of types of recording materials having different colors. The instruction section 82 causes the generative AI module 31 to generate an image based on the recording material information RI. The receiving section 83 receives the generated image GI generated by the generative AI module 31. The image transmission section 86 transmits the received generated image GI to the printing device 11 that performs printing using a recording material. According to this configuration, since the color based on the recording material information RI relating to the plurality of types of recording materials having different colors is reflected in the generated image GI, it is possible to effectively reduce the variation in the remaining amount of the recording material by printing the generated image GI.

(1-20) The printing method includes the following (A) to (C).

(A) Acquiring recording material information RI relating to a plurality of types of recording materials having different colors.

(B) Generating an image by the generative AI module 31 based on the recording material information RI.

(C) Printing the generated image GI generated by the generative AI module 31 using the recording material.

According to this printing method, since the color based on the recording material information RI relating to the plurality of types of recording materials having different colors is reflected in the generated image GI, it is possible to effectively reduce the variation in the remaining amount of the recording material by printing the generated image GI.

### Second Embodiment

Next, a second embodiment will be described with reference to FIGS. 16 to 18 and the like. In the second embodiment, an image file including image data of a slide for presentation is generated from a document file or spreadsheet file including information of characters and numbers, such as Word and Excel. The document file or the spreadsheet file is the input image II that also serves as the print image PI. An image generation confirmation screen 100 is displayed on a terminal device 20 based on an operation related to print by a user.

When a document file or a spreadsheet file is printed, if an instruction to generate image data including a slide for presentation by a generative AI is received, it is confirmed whether or not AI image generation using recording material information RI is desired. The terminal device 20 may determine the printing device 11 from which the recording material information RI is acquired from the printing device 11 that is automatically connected, or may cause the user to select the printing device 11. Here, when the YES button 103 is selected on the image generation confirmation screen 100, image data including a slide for presentation is generated based on the recording material information RI, as in the first embodiment. The image data includes a graph within a slide. The image generation section 73 sets the color of the graph or the color of the characters in the slide for which the AI image is generated to the consumption color selected based on the recording material information RI. This reduces the variation in the remaining amount of ink after the image data of the slide is printed.

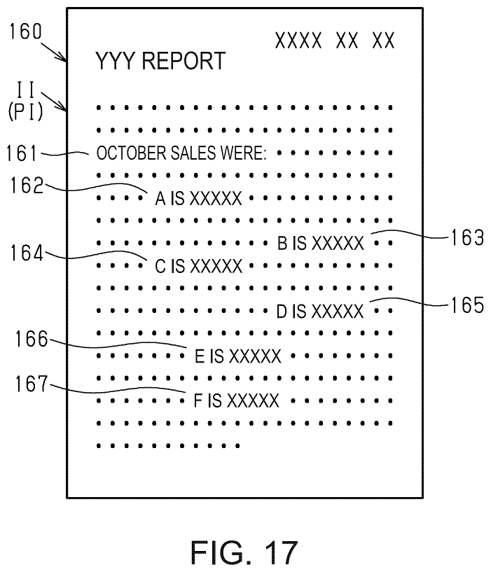

FIG. 17 illustrates document data 160 which is the input image II. The document data 160 is also referred to as a print image PI to be printed. The document data 160 is, for example, a report. The report includes items A, B, . . . F and numerical values corresponding to the items as information for generating a graph. For example, the document data 160 includes a text 161 “sales in October”, a plurality of items A to F as breakdown thereof, and texts 162 to 167 of numerical values related to the respective items A to F. The items are, for example, branch office, product, or the like, and the numerical value of the text is sales or the like.

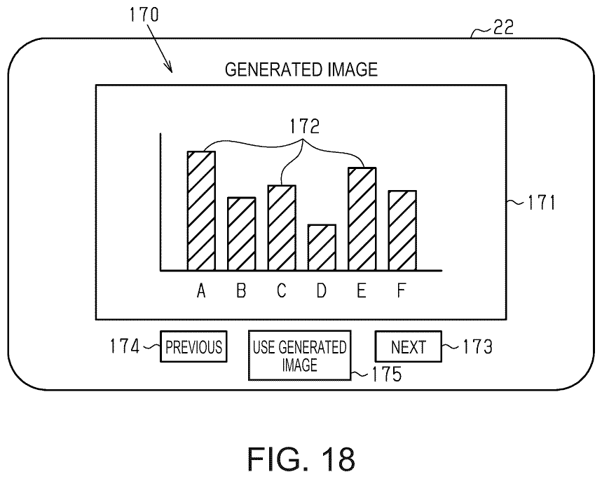

The print selection screen 170 illustrated in FIG. 18 has a generated image GI including a graph 171. The graph includes a bar section 172 that constitutes a bar graph. The bar section 172 is a color that can be printed using the recording material of the consumption color. The print selection screen 170 includes a next button 173 operated to advance to the next generated image GI, a previous button 174 operated to return to the previous generated image GI, and an apply button 175 for applying the generated image GI as a print target.

A display section 22 is provided that displays a print selection screen 170 for selecting an image to be printed from a plurality of images including a generated image GI. The print selection screen 170 includes an image GI generated by the generative AI module 31 based on the recording material information RI and an image generated by the generative AI module 31 not based on the recording material information RI. The display section 22 may display the print selection screen 170 on which the user can select a slide including a graph generated based on the recording material information RI and a slide including a graph generated not based on the recording material information RI. It should be noted that the slide may be generated from text entered by the user rather than from a document or spreadsheet file such as Word or Excel.

The printing system 10 executes processing based on a sequence similar to the sequence illustrated in FIG. 16. When the terminal device 20 receives an instruction to print the document data 160, which is the original image, the terminal device 20 converts the document data 160, which is the original image, into print data and then transmits the print data to the printing device 11 (steps S11 and S12). The printing device 11 receives the print data and prints a document based on the document data (steps S13 and S14). When the image generation instruction is received, the terminal device 20 determines whether or not to generate an image using the recording material information RI (steps S15 and S16). If the determination is affirmative (YES), the recording material information RI is acquired from the printing device 11 (steps S17 and S18). The terminal device 20 generates an image generation command including the prompt generated using the recording material information RI and the document data 160, and transmits the command to the generative AI module 31 (steps S19 and S20).

The generative AI module 31 that has received the image generation command analyzes the document data 160 in accordance with the instruction of the prompt to acquire the plurality of items A to F and the texts 162 to 167 of the numerical values corresponding to the respective items. Further, the generative AI module 31 generates the generated image GI including the graph 171 based on the acquired plurality of sets of items and numerical values (steps S21 and S22). The terminal device 20 displays the generated image GI received from the generative AI module 31, and when receiving permission to print from the user on the print confirmation screen 140, the terminal device 20 converts the generated image GI into print data and transmits the print data to the printing device 11 (steps S23 and S24). The transmission of the print data to the printing device 11 is performed by the image transmission section 86. The printing device 11 prints the generated image GI based on the received print image (steps S25 and S26).

In the graph 171 of the generated image GI, a plurality of bar sections 172 are colored with colors in which the recording materials of, for example, cyan (C) and light cyan (LC), which are consumption colors, are mainly consumed. Therefore, by printing the generated image GI, the variation in the remaining amount of the recording material among the plurality of recording material containers 53 is reduced. Therefore, the frequency of replacing a plurality of recording material containers 53 at a time is increased.

### Effects of Second Embodiment

According to the second embodiment, the following effects can be obtained in addition to the effects (1-1) to (1-20) in the first embodiment.

(2-1) The printing system 10 includes the display section 22 that displays the print selection screen 170 for selecting an image to be printed from a plurality of images including the generated image GI. According to this configuration, the user can select a desired image to be printed from among the plurality of images including the generated image GI.

(2-2) The print selection screen 170 includes the image GI generated by the generative AI module 31 based on the recording material information RI and the image generated by the generative AI module 31 not based on the recording material information RI. According to this configuration, the user can select one desired image from the image GI generated based on the recording material information RI and the image generated not based on the recording material information RI.

(2-3) The generative AI module 31 is caused to generate an image GI from the document. According to this configuration, the content of the document is easily visually understood by the image GI corresponding to the content of the document, and thus the printing frequency of the image GI is likely to increase. Therefore, the effect of suppressing the variation in the remaining amount of the recording material is enhanced.

### Third Embodiment

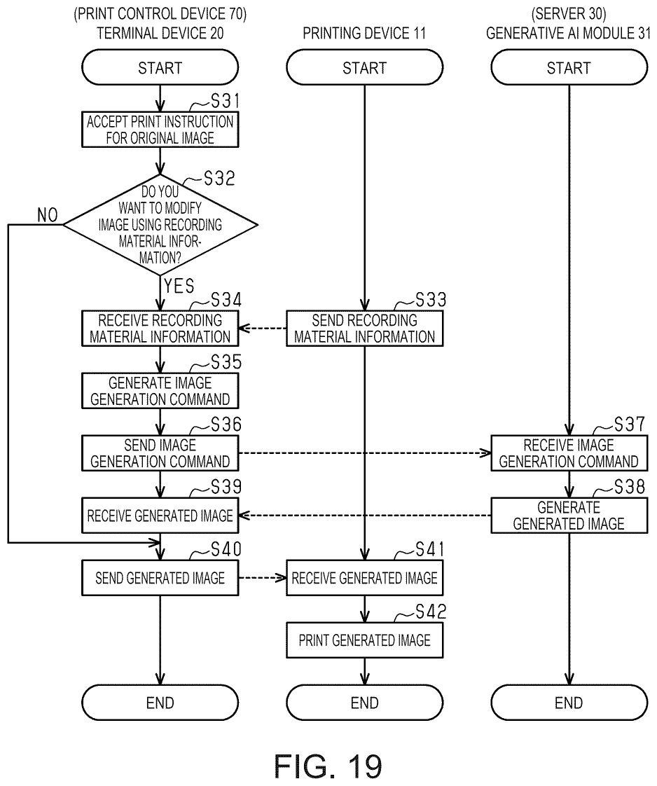

Next, a third embodiment will be described with reference to FIGS. 19 to 21 and the like. In the above embodiments, the input image II as the original data is the print image PI, but in the third embodiment, the input image II is a file of presentation material before printing. The presentation material creation application is, for example, “Microsoft (registered trademark) PowerPoint (registered trademark)”, which is presentation software manufactured by Microsoft Corporation.

The printing system 10 of the present embodiment executes the printing process including the recording material remaining amount reduction mode based on the sequence shown in FIG. 19.

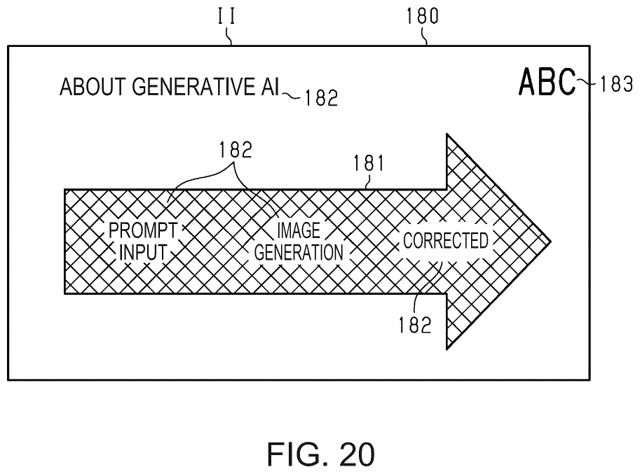

FIG. 20 illustrates an input image II input to the terminal device 20 by the user. The input image II is used as original data (original image) for AI image generation. The print control device 70 of the terminal device 20 that has received the input image II causes the generative AI module 31 to generate the image GI using the input image II as original data before printing the input image II.

The input image II illustrated in FIG. 20 includes, for example, image data 180 consisting of a slide for presentation. The input image II may be, for example, a file including a plurality of image data consisting of the slide. FIG. 20 illustrates image data 180 including one slide image in a file as an input image II. The input image II may be a file including a plurality of image data 180. The image data 180 includes the objects 181 and 182 that is an editable element and a template 183 that is a non-editable element.

Here, the objects 181 and 182 include text including characters and the like, and graphics such as arrows. The template 183 includes a logo, such as a company logo, that is not editable. The template 183 is set in the slide master as a part common to a plurality of slides, for example. For example, parts such as a background, a logo, and a project name set in the slide master are the template 183 that is uneditable elements. A part for which editing is restricted is also a template 183 that is an uneditable element. Note that parts such as the background and the project name, which are not set as the slight master and for which no editing restriction is set, are editable, and thus are objects that are editable elements. The user may be allowed to freely set the parts included in the template 183, which is an uneditable element.

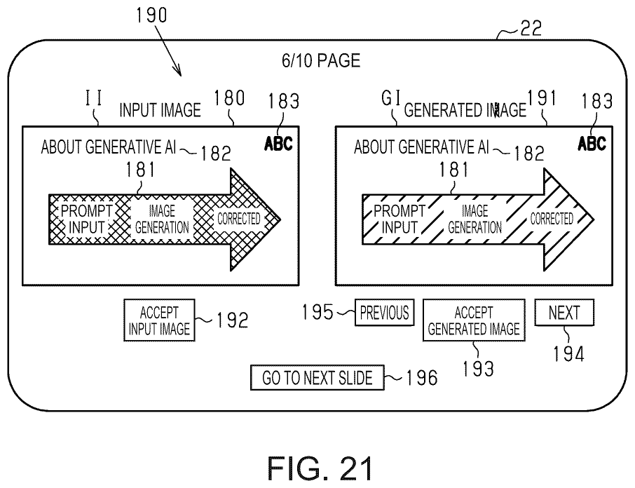

FIG. 21 is a print selection screen 190 generated by the image generation section 73 of the terminal device 20 using the input image II and the generated image GI. The terminal device 20 includes a display section 22 that displays the print selection screen 190. The print selection screen 190 is a screen for selecting an image to be printed from a plurality of images including the generated image GI. The print selection screen 190 includes a generated image GI generated by the generative AI module 31 based on the recording material information RI and an image generated by the generative AI module 31 not based on the recording material information RI. In the generated image GI generated by the generative AI module 31 based on the recording material information RI using the input image II as the original data, the color of the objects 181 and 182 in the image data 180 are changed based on the recording material information RI, and the color of the template 183 is not changed.

In the print selection screen 190 illustrated in FIG. 21, the input image II, which is the original image, and the generated image GI are arranged at positions that can be compared with each other. FIG. 21 illustrates a page on which one image data 180 of plural sets of image data 180 constituting the input image II is displayed. The image data 180 constituting the input image II and the image data 191 constituting the generated image GI are arranged at positions where they can be compared with each other for each page. In the example of the print selection screen 190 illustrated in FIG. 21, a plurality of pieces of image data 191 constituting the generated image GI can be compared with one piece of image data 180 constituting the input image II while being switched.

The print selection screen 190 includes a selection button 192 for adopting the input image II and a selection button 193 for adopting the generated image GI for each page. The print selection screen 190 further includes a next button 194 operated to switch the generated image GI to the next image, and a previous button 195 operated to switch the generated image GI to the previous image. The plural pieces of image data 191 constituting the generated image GI are constituted by a plurality of types of generated images GI in which the colors of the objects 181 and 182 printed using the recording materials of the consumption colors are different.

In the example shown in FIG. 21, the color of the arrow mark object 181 in the input image II is, for example, a magenta-based color. The color of the arrow mark object 181 in the generated image GI is, for example, a cyan-based color. When the generated image GI is switched, the color of the object 181 of the arrow mark is switched to a different cyan-based color or a color that is a mixed color of the color of cyan and a small proportion of another color. Here, the instruction section 82 gives an instruction to set the color arrangement of the image GI to be generated by the generative AI module 31 to a color arrangement in which the consumption of the recording material of the consumption color whose consumption is to be increased based on the recording material information RI is increased and the consumption of the recording material of the consumption suppression color whose consumption is to be suppressed based on the recording material information RI is reduced. Therefore, in the example illustrated in FIG. 21, the color arrangement of the generated image GI is determined to be a color arrangement that increases the consumption amount of the recording material of cyan (C), which is the consumption color, based on the recording material information RI and decreases the consumption amount of the recording material of magenta (M), which is the consumption suppression color, based on the recording material information RI. For example, in FIG. 6, the threshold value for determining the consumption suppression color is defined as a value of the remaining amount of a difference ΔSL smaller than a difference ΔS of the remaining amount for defining the threshold value for determining the consumption color with respect to the minimum remaining amount. Then, the instruction section 82 may select, as the consumption suppression color, the color of the recording material in which the difference in the remaining amount with respect to the minimum remaining amount is equal to or less than ΔSL based on the recording material information RI.

The print selection screen 190 has a selection button 196 for go to next slide. The user compares the input image II and the generated image GI for each page while selecting the selection button and switching to the slide of the next page, and selects the desired generated image GI or the input image II as the print target by switching the generated image GI for each page.

When the selection of the image data 180 consisting of the slides is completed for all the pages on the print selection screen 190, a print confirmation screen 140 illustrated in FIG. 14 and a save confirmation screen 150 illustrated in FIG. 15 are sequentially displayed on the display section 22. The user prints, for example, all slides constituting the file for presentation by selecting the YES button on the print confirmation screen 140 illustrated in FIG. 14. A file for presentation including the image data 180 and 191 selected by the user for each page can be saved in another file regardless of whether printing is performed.

### Operations of Third Embodiment

Hereinafter, the operation of the printing system 10 will be described with reference to FIG. 19.

First, in step S31, the terminal device 20 receives an instruction to print an original image. The input image II is an original image. The terminal device 20 displays an image generation confirmation screen 100. The user selects the YES button 103 in a state where the ink remaining amount variation reduction mode is enabled.

In step S32, the terminal device 20 determines whether or not to correct the image using the recording material information RI. When the remaining ink amount variation reduction mode is enabled, the terminal device 20 determines to correct the image using the recording material information RI. If the image is to be corrected, the process proceeds to step S34, and if the image is not to be corrected, the process proceeds to step S40.

In step S33, the printing device 11 transmits the recording material information RI. After the printing of the original image is completed, the recording material information RI is transmitted to the terminal device 20.

The processing of step S33 to step S42 is the same as the processing of step S17 to step S26 in the first embodiment.

When the recording material information RI transmitted from the printing device 11 is received, the terminal device 20 generates an image generation command (steps S33 to S35). The terminal device 20 transmits an image generation command to the generative AI module 31 (step S36). The generative AI module 31 that has received the image generation command generates the generated image GI based on the image generation command (steps S37 and S38). The generative AI module 31 generates a plurality of generated images GI in which the color of the objects 181 and 182 are a different color using the consumption color for each page based on the consumption color selected from the recording material information RI, the input image II, and the image generation command by the prompt.

The terminal device 20 displays the print selection screen 190 (FIG. 21) in which the generated image GI received from the generative AI module 31 is compared with the input image II (step S39). The user selects an image to be printed from the input image II and the generated image GI on the print selection screen 190. The terminal device 20 transmits the image to be printed to the printing device 11 (step S40). At this time, in a case where the image is not corrected using the recording material information RI in step S32, the input image II is transmitted to the printing device 11 as the image to be printed. The printing device 11 prints the image received from the terminal device 20 (steps S41 and S42).

### Effects of the Third Embodiment

According to the third embodiment, the following effects are obtained in addition to the effects (1-1) to (1-7) and (1-9) to (1-20) in the first embodiment.

(3-1) The printing system 10 includes the display section 22 that displays the print selection screen 190 for selecting an image to be printed from a plurality of images including the generated image GI. According to this configuration, the user can select a desired image to be printed from among the plurality of images including the generated image GI.

(3-2) The print selection screen 190 includes the image GI generated by the generative AI module 31 based on the recording material information RI and the image generated by the generative AI module 31 not based on the recording material information RI. According to this configuration, the user can select one desired image from the image GI generated based on the recording material information RI and the image generated not based on the recording material information RI.

(3-3) The input image II is a file including a plurality of image data including the objects 181 and 182 which is an editable element and the template 183 which is an uneditable element. In the generated image GI generated by the generative AI module 31 based on the recording material information RI using the input image II as the original data, the color of the objects 181 and 182 in the image data is changed based on the recording material information RI, and the color of the template 183 is not changed. According to this configuration, since the generated image GI in which the color based on the recording material information RI regarding the plurality of types of recording materials having different colors is reflected in the color of the objects 181 and 182 are generated, it is possible to effectively reduce the variation in the remaining amount of the recording material by printing the generated image GI.

(3-4) The color arrangement of the image GI that the instruction section 82 causes the generative AI module 31 to generate is a color arrangement that increases the consumption of the recording material of the consumption color based on the recording material information RI and reduces the consumption of the recording material of the consumption suppression color based on the recording material information RI. Therefore, it is possible to more effectively reduce the variation in the remaining amount of the plurality of recording materials.

### Fourth Embodiment

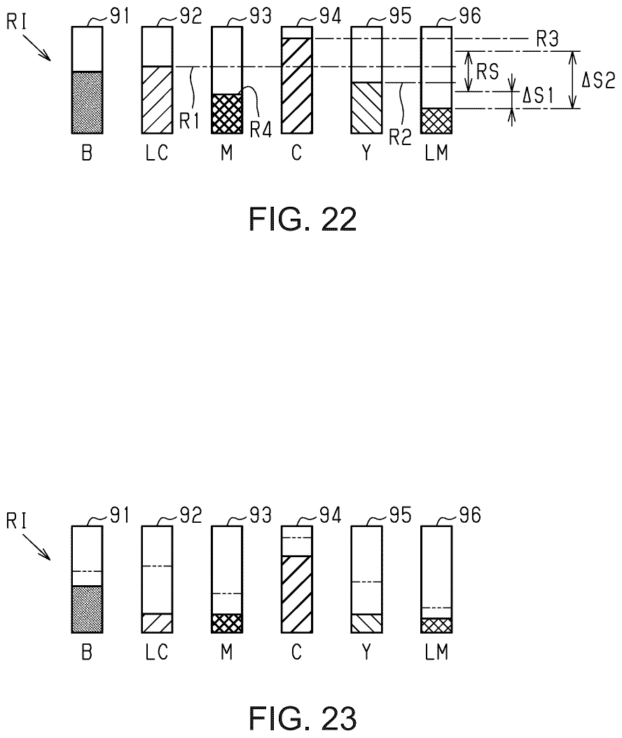

Next, a fourth embodiment will be described with reference to FIGS. 22 and 23. In the present embodiment, the comparison section 85 constituting the prompt generation section 84 compares the recording material information RI, and the consumption color selection condition for selecting the consumption color are different from that of each of the above-described embodiments.

The comparison section 85 determines a consumption color, which is a color of the recording material to be consumed in order to reduce the variation in the remaining amount, based on a comparison result obtained by comparing the remaining amounts of the respective colors based on the recording material information RI. The threshold value of the consumption color selection condition for selecting the consumption color based on the comparison process is different from that of each of the above-described embodiments.

As illustrated in FIG. 22, when a value larger than the minimum remaining amount (light magenta in FIG. 22) among the plurality of colors by the first difference ΔS1 is set as a lower limit and a value larger than the minimum remaining amount by the second difference ΔS2 is set as an upper limit, the comparison section 85 selects a color having a remaining amount within a range RS of the lower limit or more and the upper limit or less as a consumption color. In the example illustrated in FIG. 22, the comparison section 85 selects two colors of light cyan LC and yellow (Y), which are the remaining amounts R1 and R2 within the range RS, as consumption colors. Cyan (C), which is the largest remaining amount R3, deviates to the larger side of the range RS defined by the consumption color selection condition, and is not selected as a consumption color. Further, magenta (M) of the remaining amount R4 and light magenta (LM) of the minimum remaining amount deviate from the range RS to the smaller side, and therefore are not selected as the consumption color.

The prompt generation section 84 generates a prompt including the consumption color selected by the comparison section 85 from the comparison processing. The instruction section 82 causes the generative AI module 31 to generate an image using the prompt as an image generation command. The generative AI module 31 generates an image GI having the consumption color included in the prompt as a main color, and transmits the image GI to the terminal device 20. The receiving section 83 of the terminal device 20 receives the generated image GI from the generative AI module 31. When the user selects printing of the generated image GI by operating the input section 21, the print driver 72 of the print control device 70 instructs the printing section 50 to print the generated image GI. The printing section 50 prints the generated image GI. In this manner, the printing section 50 prints the generated image GI, and thus the more recording material of the consumption color is consumed than the other recording materials.

Therefore, as in the recording material information RI illustrated in FIG. 23, the consumption amount of the two colors of light cyan (LC) and yellow (Y), which are the consumption colors, is larger than the consumption amount of the recording materials of the other colors. Therefore, the variation in the remaining amount of the recording material is reduced in FIG. 23 after the generated image GI is printed, compared to FIG. 22 before the generated image GI is printed. As a result, the recording material containers 53 of four colors (LC, M, Y, and LM) of the six colors of recording materials can be replaced at a time. In this way, when the recording material containers 53 of the four colors are replaced, the variation between the remaining amounts of the recording materials of the four colors and the remaining amount of the recording material of cyan (C) which has not been replaced is reduced.

### Effects of the Fourth Embodiment

According to the fourth embodiment, the following effects can be obtained in addition to the effects (1-1) to (1-20) in the first embodiment and the effects in the second and third embodiments.

(4-1) The threshold value for determining the consumption color based on the remaining amount information in the recording material information RI includes a lower limit threshold value and an upper limit threshold value. Specifically, the color of the recording material having the remaining amount within a range RS in which a value larger than the minimum remaining amount by a first difference ΔS1 is set as a lower limit value and a value larger than the minimum remaining amount by a second difference ΔS2 (>ΔS1) is set as an upper limit value is set as the consumption color. Therefore, since consumption of the recording material having a remaining amount with an excessively large difference from the minimum remaining amount is suppressed, as a result of replacement of the recording material container 53 corresponding to the color in which consumption of the recording material is promoted by printing of the generated image GI, it is possible to reduce variation in the remaining amounts of the plurality of recording materials. Further, a plurality of recording material containers 53 can be replaced at a time. Therefore, the replacement frequency of the recording material container 53 per the number of times of printing can be reduced.

### Fifth Embodiment

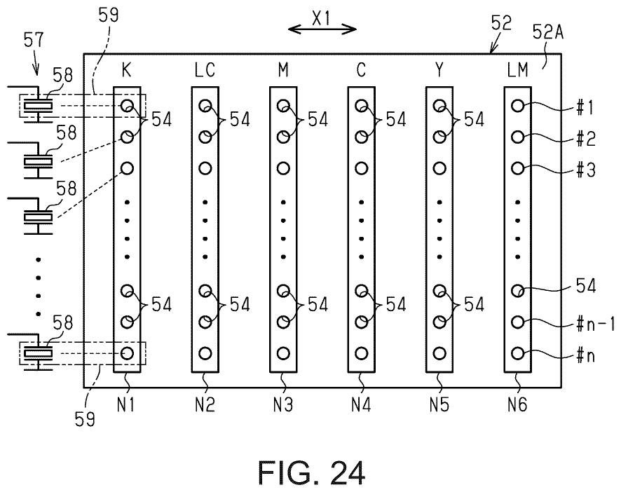

Next, a fifth embodiment will be described with reference to FIG. 24 and the like. In the present embodiment, the recording material information RI includes unused period information of printing using the recording material. The instruction section 82 causes the generative AI module 31 to generate an image based on the recording material information RI including the unused period information which is information on the unused period of the printing section 50. The recording material information RI may include non-ejection period information of the print head 52 constituting the printing section 50 in addition to the remaining amount information of the recording material. First, before describing the unused period, a configuration related to the ejection of the print head 52 will be described.

As illustrated in FIG. 24, the print head 52 has the same number (for example, six) of nozzle arrays N1 to N6 as the number of colors of ink, each of the nozzle arrays including n (for example, 100 to 500) nozzles 54 of #1 to #n opened in the nozzles opening surface 52A (bottom surface). The print head 52 includes n ejection drive elements 58, which are illustrated in FIG. 24 at positions corresponding to the n nozzles 54 constituting the nozzle array N1, for each nozzle array. The ejection drive element group 57 is configured by a plurality of ejection drive elements 58 corresponding to the number of nozzle arrays. The nozzles 54 and the ejection drive element 58 constitute an ejection section 59. The ejection drive element 58 is formed of, for example, a piezoelectric element or an electrostatic driving element capable of generating vibration for ejecting a liquid such as ink from the nozzles 54. The ejection drive element 58 may be a heater element that heats the ink and ejects ink droplets from the nozzles 54 using the pressure (expansion pressure) of bubbles generated by film boiling.

When the frequency of use of the nozzles 54 of a specific color is high during printing, the frequency of use of the other nozzles 54 is low, and therefore, the ink in the nozzles 54 is not replaced. Therefore, the ink in the nozzles 54 having a low use frequency is likely to thicken. The increase in viscosity of the ink in the nozzles cause a ejection failure. Therefore, the ink in the nozzles 54 is refreshed by ejecting the ink that is not related to printing toward a target (for example, a cap) other than the medium M every time a certain period of time elapses. In this way, the ejection failure caused by the thickening of the ink in the nozzles 54 is suppressed.

The control section 60 may measure the non-ejection period of the nozzles 54 during printing, and store the measured non-ejection period information in the memory section 62. In a case where the printing device 11 is an ink jet type, the non-ejection period information corresponds to an example of unused period information of the recording material during printing. The non-ejection period information is the non-ejection period of the nozzles 54 having the longest non-ejection period among the plurality of (n) nozzles 54 belonging to the nozzle array for each color. In this manner, the control section 60 stores the non-ejection period information in the memory section 62 as the unused period information for each color (for example, for each nozzle array). When the unused period based on the unused period information is long, there is a possibility that the nozzle array includes the nozzles 54 in which the ink in the nozzles 54 is thickened. The control section 60 performs a nozzle inspection for inspecting the presence or absence of an ejection failure of the nozzles 54. When a ejection failure of the nozzles is detected by the nozzle inspection result, cleaning for forcibly ejecting the ink from the nozzles 54 is performed by the maintenance section 56. When the nozzle clogging is severe, the cleaning strength is high. Since the cleaning forcibly ejects the ink from the nozzles 54, the ink is consumed regardless of the printing. Therefore, it is preferable to perform printing in which ink is ejected from the nozzles at an appropriate timing so that the unused period does not become too long.

Therefore, in the present embodiment, the instruction section 82 causes the generative AI module 31 to generate an image based on the recording material information RI including the unused period information. For example, the instruction section 82 specifies the nozzle array to which the nozzles 54 having a long unused period belongs based on the unused period information. The instruction section 82 selects the color corresponding to the specified nozzle array as a consumption option color which is an option of the consumption color so as to use the color for printing. On the other hand, the instruction section 82 selects a color satisfying the consumption color selection condition shown in the first embodiment as a consumption color based on the remaining amount information indicating the remaining amount of each color in the recording material information RI. If the consumption color and the consumption option color are the same, a generated image using the color is generated. When the consumption color and the consumption option color are different from each other, the control section 60 instructs to include the consumption option color in the color of the generated image unless the consumption option color is the remaining amount equal to or less than the threshold value.

### Effects of Fifth Embodiment

According to the fifth embodiment, the following effects can be obtained in addition to the effects (1-1) to (1-20) in the first embodiment and the effects in the second to fourth embodiments.

(5-1) The recording material information RI includes unused period information of printing using the recording material. In addition to the recording material information RI, the image GI of the color reflecting the unused period information of the printing using the recording material can be generated. Therefore, by printing the generated image GI, it is possible to reduce the variation in the remaining amount of the recording material, and reduce the occurrence frequency of printing errors due to a long unused period of printing using the recording material by the printing section 50. For example, when the printing device 11 is an ink jet type, it is possible to reduce printing errors such as missing dots due to ejection failure of the nozzles 54. In addition, it is possible to suppress an increase in the cleaning frequency and the execution of cleaning with high intensity.

The above-described embodiment may be changed into the embodiment such as the following modified examples. Further, an appropriate combination of the above-described embodiment and the modified examples described below may be used as a further modified example, and an appropriate combination of modified examples described below may be used as a further modified example.

When the print control device 70 receives an instruction to print a plurality of input images II, the print control device 70 may determine whether there is an amount of recording material that can be printed on the designated number of sheets, and when there is a color for which the amount of recording material is insufficient, the instruction section 82 may instruct the generative AI module 31 to change the color of the input image II so that the designated number of sheets can be printed. According to this configuration, it is possible to reduce variation in the remaining amount of the plurality of recording materials, and the user can print the designated number of images. For example, it is possible to avoid a situation in which the number of presentation documents is insufficient.

In the sequences shown in FIGS. 16 and 19 of the first and second embodiments, the printing based on the reception of the print instruction of the original image may be omitted, and the process may be started from the reception of the instruction of the image generation. That is, in FIG. 16, the steps S11 to S14 are eliminated, and the process is started from the step S15. In FIG. 19, step S31 is replaced with the reception of an instruction to generate an image, instead of the reception of an instruction to print an original image. The user can instruct the generative AI module 31 to generate an image by activating the application of the first image generation section 73 by operating the input section 21 of the terminal device 20. The first image generation section 73 causes the display section 22 to display, for example, an image generation confirmation screen 100 illustrated in FIG. 9 at the time of activation. The message MS1 in the image generation confirmation screen 100 includes image generation not based on the recording material information RI, and may simply read, for example, “Do you want to generate AI generated image?”. In this way, the user may use the application for the purpose of AI image generation, regardless of printing. In this case, the application may be used for the purpose of AI image generation using the input image II. The instruction section 82 may cause the generative AI module 31 to generate the image GI based on the recording material information RI and the input image information IS including the input image II. The instruction section 82 may cause the generative AI module 31 to generate the image GI based on information (for example, text information) including a prompt input by the user in addition to the recording material information RI. The first image generation section 73 may cause the display section 22 to display a print confirmation screen 140 for confirming execution of printing of the generated image GI. The first image generation section 73 may cause the display section 22 to display a print selection screens 170 and 190 for selecting an image to be printed from a plurality of images including the generated image GI. The print selection screens 170 and 190 may include the image GI generated by the generative AI module 31 based on the recording material information RI and an image generated by the generative AI module 31 not based on the recording material information RI. In a case where the instruction section 82 is configured to cause the generative AI module 31 to generate the image GI based on the recording material information RI, the printing system 10 may further include a prompt generation section 84 that generates a prompt, which is an image generation command, based on the recording material information RI. After the image is generated, the user may be allowed to select whether or not to save the generated image as a separate file.

In the first embodiment and the above-described modification example, the generated image GI generated by the generative AI module 31 based on the recording material information RI illustrated in FIG. 13 and the generated image generated by the generative AI module 31 not based on the recording material information RI may be displayed on the display section 22 so as to be selectable.

In the second embodiment and the above-described modification example, only one generated image GI based on the recording material information RI illustrated in FIG. 18 may be displayed on the display section 22.

In the second embodiment and the above-described modification example, as the generated image GI based on the recording material information RI illustrated in FIG. 18, a plurality of generated images GI having different types of graphs may be selectable.

In the second embodiment and the above-described modification example, the process may be started from the reception of the instruction to generate an image (for example, step S15 in FIG. 16). Accordingly, for example, a conference record including a figure such as a mind map or a fishbone diagram may be generated from the audio data or the video data of the conference. An example of this type of generative AI module 31 is “Mapify” or the like that can generate a mind map including keywords from audio or images (including moving images).

The instruction section 82 may instruct the generative AI module 31 to perform an extraction process of searching for a frame image satisfying a color arrangement based on the recording material information RI from the moving image data as the input image II. In this case, the instruction section 82 may cut out a specific region including a portion to which the color arrangement is applied from the searched frame image and use the specific region as the generated image GI.

The instruction section 82 may extract a frame image including a graph, a table, a mind map, and the like from the moving image data, and may cause the generative AI module 31 to generate the image GI by an instruction to apply a color arrangement based on the recording material information RI to the graph and the like.

The instruction section 82 may generate the image GI to which the color arrangement based on the recording material information RI is applied by cooperation of processes of giving different instructions to different generative AI modules 31 of the plurality of servers 30.

In the second embodiment and the above-described modification example, the generated image GI may be obtained by incorporating the graph 171 or the table into the document data 160 which is the original data. The graph 171 or the table to be incorporated may be generated by the generative AI module 31 based on the text or the numerical value in the document data 160.

In the above-described embodiments, the plurality of types of recording materials in the recording material information RI relating to the plurality of recording materials having different colors are recording materials of colors other than black, but the recording material information RI may include information relating to a black recording material. The recording material information RI may include information on two or more types of recording materials. That is, the recording material information RI may include information on a recording material of a first color and information on a recording material of a second color different from the first color. The recording material information RI is not limited to including all colors, and may include at least two colors among all colors.

In the embodiment, the acquisition section 81 is included in the image generation section 73 of the terminal device 20, but the acquisition section may be included in the first server 30 or the second server 40. In this case, the instruction section may not include the recording material information RI itself in the instruction to cause the generative AI module 31 to generate an image based on the recording material information, and may be an instruction to cause the generative AI module 31 to generate an image after acquiring the recording material information. In this case, the generative AI module 31 that has received the instruction from the instruction section may include the acquisition section, and the acquisition section of the generative AI module 31 may access the terminal device 20 or the printing device 11 to acquire the recording material information RI.

In the embodiment, the terminal device 20 (the print control device 70) includes the image generation section 73, but the second server 40 may include the image generation section 73. That is, the second server 40 may include the acquisition section 81, the instruction section 82, and the receiving section 83. In this case, the second server 40 may communicate with the terminal device 20 to instruct the display section 22 to display a confirmation screen or the like.

The acquisition section 81, the instruction section 82, and the receiving section 83 do not need to be collectively provided in only one of the terminal device 20 and the printing device 11, and may be separately provided in one of the terminal device 20 and the printing device 11. At least one of the acquisition section 81, the instruction section 82, and the receiving section 83 may be provided in the second server 40.

Although the terminal device 20 generates the image generation command (prompt), the printing device 11 may generate the image generation command. The instruction section 82 of the second image generation section 65 may generate the image generation command by the prompt generation section 84.

The generative AI module 31 may be included in the second server 40. For example, the second server 40 may include the generative AI module 31 having a generation AI model including a learned LLM dedicated to printing designed by a manufacturer or the like of the printing device 11. In this case, the generative AI module 31 of the first server 30 may not be used, or the generative AI module 31 of each servers 30 and 40 may be used together. In the case of instructing the dedicated generative AI module 31, the remaining ink amount data may be simply transmitted as the recording material information RI, instead of the instruction by the prompt.

The terminal device 20 may include the generative AI module 31. In this case, the print control device 70 may include the generative AI module 31. The print control device 70 may include all of the acquisition section 81, the instruction section 82, the receiving section 83, and the generative AI module 31. The print control device 70 may further include a prompt generation section 84.

The printing device 11 may include the generative AI module 31. The printing device 11 may include all of the acquisition section 81, the instruction section 82, the receiving section 83, the printing section 50, and the generative AI module 31. The printing device 11 may further include a prompt generation section 84.

The printing device 11 may be a tank type which is a tank capable of storing liquid such as ink which is an example of the recording material instead of a cartridge type in which the recording material container 53 is replaceable. In a case where the recording material container 53 is a tank, the user replenishes the tank with a liquid such as ink by using a bottle. The tank-type printing device 11 may include a plurality of viewing windows in the main body 12, through which the user can visually check the remaining amount of the recording material (remaining amount of ink) in the recording material container 53. The user may use, as the recording material information RI, a remaining amount image obtained by imaging the remaining amounts of the plurality of viewing windows with a camera of the terminal device 20 such as a smartphone. The acquisition section 81 may acquire the remaining amount image as the recording material information RI. For example, an uploading section for uploading an image relating to the recording material information RI may be provided on the screens 100, 110, 120, and 130 or the like displayed on the display section 22, and the remaining amount image may be uploaded. The instruction section 82 may attach the remaining amount image as it is, or may instruct the generative AI module 31 to generate an image by a prompt including the recording material information RI including text or a table acquired by analyzing the remaining amount image. The prompt generation section 84 may generate a prompt, which is an image generation command, based on the remaining amount image. In this case, a prompt including the remaining amount image may be generated, only the remaining amount image may be generated, or a prompt including text of the analysis result of the remaining amount image may be generated. In the tank-type printing device 11, the variation in the remaining amount of the recording material is reduced, and thus the frequency at which the user can replenish the plurality of recording material containers 53 (tanks) with the recording material at a time increases. Therefore, the frequency of refilling the recording material container 53 with the recording material per printing operation can be reduced.

A remaining amount image obtained by imaging the plurality of remaining amount scales 91 to 96 on the remaining amount notification screen 90 illustrated in FIG. 5 with a camera of the terminal device 20 such as a smartphone may be used as the recording material information RI. In this case, the acquisition section 81 may acquire the remaining amount image as the recording material information RI. The instruction section 82 may include the remaining amount image in a part of the prompt. The prompt may be only the remaining amount image. Even in the case of the prompt including only the remaining amount image, the generative AI module 31 can generate the color generation image GI in which the color of the recording material having a large remaining amount is the consumption color by analyzing the captured image and acquiring the remaining amount of each color.

In each of the embodiments, before the prompt is transmitted, it is confirmed whether or not the image may be generated using the recording material information on the image generation confirmation screen 100, but a configuration may be adopted in which whether or not the AI image generation is possible can be confirmed in the initial setting of the print driver 72 or the like, and whether or not the AI image generation is possible can be set. In this case, when the AI image generation is permitted, a condition for permission may be set at the time of initial setting. For example, the permission may be given when the printing is photo printing, or when the variation in the remaining amount of the recording material exceeds a threshold value. In addition, not only the initial setting of the print driver, but also whether or not the AI image generation is possible, the permission condition, and the like may be set from a setting screen displayed on the display section 16 or 22 of the printing device 11 or the terminal device 20.

The user may be able to set whether or not to generate the AI image on a setting screen displayed on the terminal device 20 or the printing device 11.

The image generation confirmation screen 100 may be displayed or the AI image may be generated only when it is determined that the execution of the recording material remaining amount variation reduction mode is necessary based on the comparison result of the remaining amounts of the plurality of recording materials.

The consumption color may include a color of a recording material having a second smallest remaining amount next to a recording material having a smallest remaining amount among the plurality of recording materials. According to this configuration, by bringing the remaining amounts of two or more recording materials where the remaining amount is smallest close to each other, the frequency of replacing the plurality of recording material containers 53 at a time is increased.

The color of the recording material having the second smallest remaining amount, which has a difference ΔS from the minimum remaining amount equal to or less than a predetermined value, may be selected as the consumption color. According to this configuration, the color of the recording material of which the second smallest remaining amount is too far from the minimum remaining amount is not selected as the consumption color, and thus, the recording material is not forcibly consumed in the printing of the generated image GI. Further, after the plurality of recording material containers 53 respectively containing the recording materials with the smallest remaining amount and the second smallest remaining amount can be replaced at once with the remaining amounts equal to or less than the near-end state, the variation in the remaining amounts of the plurality of recording material containers 53 after the replacement can be reduced.

The plurality of colors may include gray. In this case, the generated image may be a grayscale image using a gray printing material. Examples of the gray scale image include an ink-wash painting, a pencil drawing, a pencil illustration, and a monochrome photograph. In a case where gray ink is used as the main consumed recording material, when the remaining amount of the black recording material is equal to or larger than the threshold value, a small amount of the black recording material may be used for printing the grayscale image.

The recording material information RI may be ink use amount information, ink non-ejection period information, or the like instead of the ink remaining amount information. The amount of the recording material in the recording material container 53 can be estimated from the non-ejection period information for each color. If the image GI is generated with the ink of the color having a long non-ejection period as the main consumption color by using the non-ejection period information for each color, the thickened ink in the nozzles of the print head 52 is ejected by printing, and thus, there is a possibility that the frequency of performing cleaning when the ejection failure occurs due to the thickened ink in the nozzles can be reduced.

In the first and second embodiments, in FIG. 16, the recording material information RI is transmitted from the printing device 11 after the printing of the print image which is the original image, but the timing may be any time as long as it is before the printing. If the remaining amount information is transmitted after the print image is printed, the remaining amount information more suitable for the current remaining amount can be obtained. On the other hand, if the recording material information is transmitted before the printing of the print image is started, the time lag from the end of the printing of the print image to the start of the printing of the generated image GI can be reduced.

In the first to third embodiments, the prompt includes the data of the print image, but the present disclosure is not limited thereto. The image included in the prompt may be an image printed in the past (for example, an image in the printing history) or an image stored in the memory in the terminal device 20. Further, the prompt may be a text additionally input by the user regardless of the print image, or may be created only by the recording material information RI.

In each of the embodiments, the instruction section 82 causes the generative AI module 31 to generate an image based on the color information of the medium M which is a printing target, but the material of the medium M is not limited to paper, a synthetic resin film, or the like. For example, the printing device 11 may be a garment printer configured to be able to print an image on a cloth product such as a T-shirt or a tote bag, or a textile printing device configured to be able to print an image on a fabric such as a woven fabric. In this case, the medium M is, for example, cloth, and the color information includes, for example, the color of the surface of the cloth. The color of the cloth may be one color, or may be a plurality of colors of two or more colors in a case where there is a pattern. In each of the embodiments and the present modification example, the instruction (for example, a prompt) given to the generative AI module 31 by the instruction section 82 may include information indicating that the color arrangement of the generated image GI is determined after determining whether or not the combination of the color information of the medium M and the color arrangement in the generated image GI is appropriate based on the recording material information RI and the color information of the medium M. The instruction may include, for example, information indicating that a color arrangement avoiding the same color or a color approximate to the color of the surface of the medium M is determined for a region adjacent to the region of the surface of the medium M in the generated image GI. In a case where there is a consumption color (first consumption color) that is the same color as or a color similar to the color of the surface of the medium M, the color arrangement may include a mixed color of the first consumption color and the second consumption color that are different colors from each other. The instruction may include at least one of a prompt and an image (for example, a photograph) before printing on the medium M.

The instruction section 82 may cause the generative AI module 31 to generate an image based on position information indicating a position on the medium M in addition to the recording material information RI. For example, the instruction section 82 may cause the generative AI module 31 to generate the image GI based on the position information of the design element applied in advance to the medium M which is a printing target. Examples of the design element include an illustration, a pattern, a logo, a ruled line, and a character. The instruction (for example, a prompt) given to the generative AI module 31 by the instruction section 82 includes, for example, information indicating that an image that can be printed in a region avoiding the design element is generated based on the position information of the design element in the medium M. The instruction may include at least one of a prompt and an image (for example, a photograph) of the medium M. The generative AI module 31 generates an image at a position avoiding the design element of the medium M based on the position information in the instruction (image generation command) received from the instruction section 82. Therefore, it is possible to avoid a design element such as a logo from being hidden by the generated image GI printed on the medium M. The position information is not limited to information indicating a position where the arrangement of the image is avoided, and may be information indicating a position where the image is arranged on the medium M.

Since the generated image GI may not conform to the policy of the company or the organization, the prompt may include a limitation on image generation, for example, a limitation from the viewpoint of personal information protection.

An image read by the image reading section 13 of the printing device 11 may be used as the input image II (original image).

In the above-described embodiments, the image generation confirmation screen 100 is displayed in all the printing operations to confirm with the user whether or not the image generation is possible, but the present invention is not limited thereto. Since the information related to the “type of medium (medium type)” which is one of the printing condition information is “photo paper”, the user may confirm whether or not to generate an image on the confirmation screen only when it is determined that the printing is photo printing. When the YES button is selected on the confirmation screen, the generative AI module 31 may be configured to generate an image.

In each of the above-described embodiments, a method of comparing the remaining amount of the recording material with the threshold value is adopted, but the consumption color may be determined only by the relative remaining amount difference of each color, or the consumption ratio of the determined consumption color in the generated image GI may be determined.

The user may be allowed to freely select a mode in which the generative AI module 31 generates an image so as to increase the consumption ratio of the consumption color in the generated image GI and other modes.

If the remaining amount is equal to or less than a predetermined threshold value, the image GI may be generated without using the recording material of the color.

The recording material information RI may be acquired by the generative AI module 31. That is, the generative AI module 31 may include the acquisition section 81. In this case, the instruction section 82 may include, in the prompt, a message (text) instructing “acquire remaining amount information from the printing device 11 of the designated address in the same network”, for example. For example, the terminal device 20 including the instruction section 82 may be a PC or the like that can access the generative AI module 31 via the network NW.

In the above-described embodiments, the information on the black recording material in the recording material information RI is not used for the instruction of the image generation, but the information on the black recording material may be used for the instruction of the image generation. The comparison section 85 may select a consumption color by comparing the remaining amounts of a plurality of recording materials including a black recording material.

The black recording material may be used less frequently for image generation than the color recording material. For example, in a case of a configuration in which an image is generated so that a color of a recording material whose remaining amount is equal to or less than a predetermined threshold is not consumed, the threshold of black may be set higher than the threshold of color.

The prompt generation section 84 includes the comparison section 85, but the comparison section 85 may be eliminated, and the generative AI module 31 may be caused to perform the comparison process by instructing the comparison process with a prompt instead.

Instead of the configuration in which the recording material consumption amount measurement section 64 measures the recording material consumption amount, a sensor that detects the amount of the recording material may be provided in the recording material container 53, and the amount (for example, the remaining amount) of the recording material may be detected based on the detection result of the sensor.

The recording material information RI may include information on a replacement time at which the recording material container 53 is replaced. Since it can be estimated that the remaining amount of the recording material container 53 is smaller as the replacement time is earlier, the consumption color may be selected by comparing the replacement times. In this way, the present invention is not limited to the comparison of the amounts of a plurality of recording materials, and at least one other piece of information in the recording material information RI estimated to obtain the same comparison result as the comparison result of the amounts or the comparison result having the same tendency may be used.

The information in the recording material information RI used for selecting the consumption color may be, for example, expiration date information relating to the expiration date of the recording material. The consumption color may be selected so that the recording material having a shorter expiration date is preferentially consumed based on the expiration date information. In this case, a threshold value may be set for the remaining period until the expiration date, and the color of the recording material whose remaining period is equal to or less than the threshold value may be selected as the consumption color. Further, in the case where the recording materials satisfying the expiration date condition include the recording material of the minimum remaining amount, the color of the recording material other than the recording material of the minimum remaining amount may also be used as the consumption color. Here, it can be estimated that the remaining amount tends to be smaller as the recording material container 53 has a shorter expiration date of the recording material. Therefore, it is possible to reduce the variation in the remaining amount of the plurality of recording materials. Accordingly, the frequency of handling by one replacement or one liquid replenishment with respect to a plurality of (two or more) recording material containers 53 is increased, and the recording material having a short expiration date can be preferentially consumed. The expiration date information may be a manufacturing date or a manufacturing lot number that can specify a manufacturing year and month, as long as the expiration date can be specified.

In a case where there are two or more groups of a plurality of recording materials having similar amounts, a variation in the remaining amounts of the two or more recording materials belonging to one group may be reduced. In this way, the remaining amount of the recording materials may be narrowed down to one group of a plurality of recording materials (for example, a plurality of colors) for which the consumption color is to be selected, and the variation in the remaining amounts of two or more recording materials belonging to the group may be reduced. Accordingly, since the variation in the remaining amount of two or more recording materials which are a part of the plurality of recording materials which are the selection targets of the consumption color is more easily reduced, it is possible to increase the frequency that can be handled by one time replacement or one time liquid replenishment with respect to two or more recording material containers 53.

The printing section 50 may not include the maintenance section 56. The printing section 50 may not include the transport section 55. The printing section 50 may be only the print head 52.

The printing device 11 is not limited to a consumer printing device for personal use or home use or a business printing device, and may be a multifunction peripheral for office use.

Hereinafter, technical ideas and effects obtained from the embodiment and the modifications will be described.

[1] A printing system includes an acquisition section

configured to acquire recording material information relating to a plurality of recording materials having different colors; an instruction section configured to cause a generative AI module to generate an image based on the recording material information; a receiving section configured to receive a generated image generated by the generative AI module; and a printing section configured to print the received generated image using the recording material.

According to this configuration, since the color based on the recording material information regarding the plurality of recording materials having different colors is reflected in the generated image, it is possible to effectively reduce the variation in the remaining amount of the recording material by printing the generated image.

[2] The printing system according to [1] may be such that the instruction section causes the generative AI module to generate an image based on input image information including an input image in addition to the recording material information.

According to this configuration, since an image in which the color based on the recording material information and the input image are reflected is generated, the user is likely to be interested in the generated image, and thus the printing frequency of the generated image is likely to increase.

[3] The printing system according to [1] or [2] may be such that the instruction section causes the generative AI module to generate an image based on information including a prompt input by a user in addition to the recording material information.

According to this configuration, the generative AI module can be caused to generate an image desired by the user. Therefore, the frequency of printing the generated image by the user is increased, and thus the variation in the remaining amount of the recording material can be effectively reduced.

[4] The printing system according to any one of [1] to may further include a display section that displays an image generation confirmation screen for confirming permission of image generation based on the recording material information.

According to this configuration, the user can permit generation of an image only when the user desires to do so, and thus it is possible to suppress a delay in printing of an input image or the like due to unnecessary generation of an image.

[5] The printing system according to any one of [1] to may further include a display section that displays the generated image and a print confirmation screen for confirming execution of printing of the generated image.

According to this configuration, the user can quickly execute printing when the user wants to print after checking the displayed generated image.

[6] The printing system according to any one of [1] to may further include a display section that displays a print selection screen for selecting an image to be printed from a plurality of images including the generated image.

According to this configuration, the user can select a desired image to be printed from among the plurality of images including the generated image.

[7] The printing system according to any one of [1] to may further include a prompt generation section that generates a prompt, which is an image generation command, based on the recording material information.

According to this configuration, the generated image according to the image generation command can be generated by the prompt generated based on the recording material information.

[8] The printing system according to [7] may be such that the prompt generation section includes a comparison section that compares the remaining amounts of the plurality of recording materials.

According to this configuration, the color of the recording material to be reflected in the prompt can be specified by comparing the remaining amounts of the plurality of recording materials. Therefore, consumption of the recording material of the specified color is promoted by printing of the generated image, and thus it is possible to effectively reduce variation in the remaining amount of the recording material.

[9] The printing system according to [2] may be such that the input image is a print image instructed to be printed, and the acquisition section acquires the recording material information after the print image is printed.

According to this configuration, since the image is generated based on the latest recording material information after the printing of the print image, it is possible to effectively reduce the variation in the remaining amount of the recording material.

[10] The printing system according to [6] may be such that the print selection screen includes an image generated by the generative AI module based on the recording material information and an image generated by the generative AI module not based on the recording material information.

According to this configuration, the user can select one desired image from the image generated based on the recording material information and the image generated not based on the recording material information.

[11] The printing system according to [4] may be such that the image generation confirmation screen is displayed based on a user operation related to printing.

According to this configuration, since the generation confirmation screen can be displayed at an appropriate timing based on the operation related to printing by the user, it is difficult for the user to fail to confirm.

[12] The printing system according to any one of [1] to [11] may be such that the recording material information includes remaining amount information of the recording material.

According to this configuration, since an image in which a color corresponding to the remaining amount information of the recording material is reflected can be generated, it is possible to reduce a variation in the remaining amount of the recording material by printing the generated image.

[13] The printing system according to any one of [1] to [12] may be such that the recording material information includes unused period information of printing using the recording material.

According to this configuration, it is possible to generate an image of a color reflecting the unused period information of printing using the recording material in addition to the recording material information. Therefore, by printing the generated image, it is possible to reduce the variation in the remaining amount of the recording material, and it is possible to reduce the occurrence frequency of the printing error due to the long unused period of the printing using the recording material by the printing section.

[14] The printing system according to any one of [1] to [13] may be such that a selection is caused to be made as to whether or not to save the generated image received by the receiving section as a separate file.

According to this configuration, the user can easily save the generated image that the user likes as a separate file.

[15] The printing system according to [2] may be such that the input image is a file including a plurality of pieces of image data each including an object that is an editable element and a template that is an uneditable element and the generated image generated by the generative AI module based on the recording material information using the input image as original data has color of the object in the image data is changed based on the recording material information and does not have the color of the template changed.

According to this configuration, since the generated image in which the color based on the recording material information regarding the plurality of types of recording materials having different colors is reflected in the color of the object is generated, it is possible to effectively reduce the variation in the remaining amount of the recording material by printing the generated image.

[16] A print control device provided in a terminal device to give print instructions to a printing device includes an acquisition section configured to acquire recording material information relating to a plurality of recording materials having different colors; an instruction section configured to cause a generative AI module to generate an image based on the recording material information; a receiving section configured to receive a generated image generated by the generative AI module; and an image transmission section configured to transmit the received generated image to a printing device configured to print the generated image using the recording material.

According to this configuration, since the color based on the recording material information regarding the plurality of types of recording materials having different colors is reflected in the generated image, it is possible to effectively reduce the variation in the remaining amount of the recording material by printing the generated image.

[17] A printing method includes acquiring recording material information relating to a plurality of recording materials having different colors; generating an image by a generative AI module based on the recording material information; and printing the generated image generated by the generative AI module using the recording material.

According to this method, since the color based on the recording material information regarding the plurality of recording materials having different colors is reflected on the generated image, it is possible to effectively reduce the variation in the remaining amount of the recording material by printing the generated image.

What is claimed is:

1. A printing system comprising:
an acquisition section configured to acquire recording material information relating to a plurality of recording materials having different colors;
an instruction section configured to cause a generative AI module to generate an image based on the recording material information;
a receiving section configured to receive the generated image generated by the generative AI module; and
a printing section configured to print the generated image using the recording material.

2. The printing system according to claim 1, wherein
the instruction section causes the generative AI module to generate an image based on input image information including an input image in addition to the recording material information.

3. The printing system according to claim 1, wherein
the instruction section causes the generative AI module to generate an image based on information including a prompt input by a user in addition to the recording material information.

4. The printing system according to claim 1, further comprising:
a display section that displays a confirmation screen for confirming permission of image generation based on the recording material information.

5. The printing system according to claim 1, further comprising:
a display section that displays the generated image and a print confirmation screen for confirming execution of printing of the generated image.

6. The printing system according to claim 1, further comprising:
a display section that displays a print selection screen for selecting an image to be printed from a plurality of images including the generated image.

7. The printing system according to claim 1, further comprising:
a prompt generation section that generates a prompt, which is an image generation command, based on the recording material information.

8. The printing system according to claim 7, wherein
the prompt generation section includes a comparison section that compares the remaining amounts of the plurality of recording materials.

9. The printing system according to claim 2, wherein
the input image is a print image instructed to be printed, and the acquisition section acquires the recording material information after the print image is printed.

10. The Printing system according to claim 6, wherein
the print selection screen includes an image generated by the generative AI module based on the recording material information and an image generated by the generative AI module not based on the recording material information.

11. The printing system according to claim 4, wherein
the image generation confirmation screen is displayed based on a user operation related to printing.

12. The printing system according to claim 1, wherein
the recording material information includes remaining amount information of the recording material.

13. The printing system according to claim 1, wherein
the recording material information includes unused period information of printing using the recording material.

14. The printing system according to claim 1, wherein
a selection is caused to be made as to whether or not to save the generated image received by the receiving section as a separate file.

15. The printing system according to claim 2, wherein
the input image is a file including a plurality of pieces of image data each including an object that is an editable element and a template that is an uneditable element and
the generated image generated by the generative AI module based on the recording material information using the input image as original data has color of the object in the image data is changed based on the recording material information and does not have the color of the template changed.

16. A print control device provided in a terminal device to give print instructions to a printing device, the print control device comprising:
an acquisition section configured to acquire recording material information relating to a plurality of recording materials having different colors;
an instruction section configured to cause a generative AI module to generate document data based on the recording material information;
a receiving section configured to receive the document data generated by the generative AI module; and
an image transmission section configured to transmit the document data to a printing device configured to print the document data using the recording material.

17. A printing method of a printing device comprising:
acquiring recording material information relating to a plurality of recording materials having different colors;
generating an image by a generative AI module based on the recording material information; and
printing the image generated by the generative AI module using the recording material.

18. The printing system according to claim 16, wherein
the instruction section causes the generative AI module to generate the document data based on an audio data or a video data in addition to the recording material information.
